(19) United States
(12) Patent Application Publication
(10) Pub. No.: US 2025/0123802 A1
(43) Pub. Date: Apr. 17, 2025

(54) Large Parameter Set Computation Accelerator Using Configurable Connectivity Mesh

(71) Applicant: Taalas Inc., Toronto (CA)

(72) Inventors: Ljubisa Bajic, Toronto (CA); Dragoljub Ignjatovic, North York (CA); Lejla Bajic, North York (CA)

(21) Appl. No.: 18/884,738

(22) Filed: Sep. 13, 2024

Related U.S. Application Data
(60) Provisional application No. 63/543,728, filed on Oct. 11, 2023.

(51) Int. Cl. G06F 7/52

(52) U.S. Cl. CPC G06F 7/52

(57) ABSTRACT

Methods and systems which involve computer architectures are disclosed herein. A disclosed system comprises a set of multipliers input-coupled to an input, a connectivity mesh, a set of readable cells, and a read circuit. Each readable cell in the set of readable cells is uniquely associated with a parameter of a vector, the parameter having a value. Each readable cell in the set of readable cells is also coupled, via the connectivity mesh, to a multiplier, from the set of multipliers, that outputs the product of the value of the parameter and the input. The read circuit reads a product of the input and the vector from the set of readable cells.

### CROSS REFERENCE TO RELATED APPLICATIONS

This application claims the benefit of U.S. Provisional Patent No. 63/543,728, filed on Oct. 11, 2023, which is incorporated by reference herein in its entirety for all purposes.

### BACKGROUND

Machine learning is experiencing a remarkable surge in importance within our society. Businesses are leveraging the capabilities of machine learning to extract actionable insights from vast datasets, automate tasks, and predict future trends with unprecedented accuracy. As a result, companies that harness the power of machine learning gain a competitive edge, while economies as a whole benefit from increased efficiency, productivity, and the creation of new markets and opportunities. However, the surge in activity has led to massive increases in the computational resources required by and consumed by machine learning applications.

The burden of increased computational cost in machine learning applications is a significant challenge that the field faces. As machine learning models become more complex and datasets grow, the demand for computational resources escalates. Training deep neural networks, for instance, can require immense amounts of processing power and memory, often pushing the limits of available hardware. This increased cost not only affects the affordability of training models but also raises environmental concerns due to higher energy consumption. Furthermore, it creates a barrier to entry for smaller organizations and researchers with limited resources. Addressing this challenge involves developing more efficient algorithms, software techniques to increase parallelization, hardware acceleration, and numerous other approaches.

Machine learning computations often demand a significant amount of matrix multiplications. Indeed, matrix multiplications are a fundamental building block of machine learning computations across various models and applications generally. In the world of fully connected neural networks, for instance, matrices represent the weights and activations of interconnected neurons in various layers. Such weights represent the model data of the neural network that has been learned through training. During training and inference, these matrices are multiplied together repeatedly to transform input data into meaningful predictions. The essence of deep learning lies in the ability to learn complex patterns by fine-tuning these matrices through backpropagation, a process that also heavily relies on matrix multiplications. As models and data sets continue to grow, the scale of the required matrix multiplications commensurately increases, necessitating specialized hardware and optimized algorithms to ensure efficient and timely execution of machine learning tasks.

### SUMMARY

Methods and systems which involve computational architectures are disclosed herein. More specifically, methods and systems which involve computational architectures for accelerating vector multiplications are disclosed herein.

As stated previously, the data structures involved in machine intelligence computations are increasing in size at a remarkable rate. Modern neural network models can contain over a trillion parameters, each of which is used in multiple computations during an execution of the model. The computations are generally matrix multiplications where each individual matrix can include billions of parameters. The result is billions, if not trillions, of discrete multiplication operations that need to be computed to conduct a matrix multiplication with that matrix.

While the number of parameters in an individual matrix can reach into the billions, the number of available values per parameter can be, in many applications, relatively limited. This is because the number of bits that are assigned to represent each parameter value is generally limited to reduce the memory and computational resources required to store and execute the model. For example, many accelerator architectures for machine learning applications utilize 8-bit data types, which can be used to represent at most 256 different values. Some accelerator architectures even utilize 4-bit data types, which can be used to represent at most 16 different values. As a result, when given a matrix with a billion parameters, it is, by comparison, facile to multiply every possible value of the parameters of the matrix by a number as compared to multiplying every parameter in the matrix by that number. From the perspective of traditional computation this is an unconventional situation as generally there are far more potential values for an unknown parameter than there are unknown parameters in a computation. However, this different way of thinking about the requirements of a large matrix computations serves as the basis for one of the many improvements of the systems and methods disclosed herein.

In specific embodiments of the invention, a system for vector multiplication is disclosed. The system can include a set of multipliers, a connectivity mesh, and a set of readable cells. The set of multipliers can be hardwired to multiply every possible value for the parameters of a vector by an input value. Each multiplier in the set of multipliers can be associated with a value in the set of every possible value for the parameters of the vector in a one-to-one correspondence. That is, each multiplier can be configured to receive the input value for the computation and a unique value from the set of every possible value for the parameters of the vector and treat those values as the operands of a multiplication. The connectivity mesh can link the outputs of the set of multipliers to a set of readable cells. The readable cells can each be associated with a parameter of the vector and be connected, by the connectivity mesh, to the output of the multiplier that is associated with the value of that parameter. The values resulting from the multiplication of the vector by the input value can then be read from the set of readable cells. This read operation results in reading, in parallel, the values of an output vector equivalent to the vector multiplied by the input value for the computation.

In specific embodiments, the input values can be values that are part of another vector, and they can be provided to the system in series to aid in the computation of a multiplication of the two vectors. The output values read from the readable cells can be accumulated after each read operation to achieve this result.

In specific embodiments, the system for vector multiplication can be part of a system used for matrix multiplication. The set of readable cells can be divided into subsets of readable cells where each subset is uniquely associated with a row or column of a matrix. The subsets of readable cells can be independently addressable and readable so that an output matrix can be assembled from a series of output values read from the subsets of readable cells.

In specific embodiments, the connectivity mesh can be configurable. For example, the connectivity mesh can include a set of programmable switches that connect the outputs of the set of multipliers to the set of readable cells. The switches can be configurable when the system is deployed. For example, the switches can be controlled through the delivery of control signals to the control nodes of the switches when the system has been fabricated and powered on. Alternatively, the switches can be configurable when the system is being fabricated. The state of the switches can be set using similar approaches to those used to store values in read only memory (ROM). The state of the switches can be set through the controlled delivery of dopants to activate specific transistors, through the use of customized layouts for the wiring layers of the device, or through the use of fuse or anti-fuses to make or break connections between different circuit nodes.

The configurability of the connectivity mesh can allow the system to serve as a computational structure for specific matrices. For example, in machine intelligence applications, the model data of a machine intelligence application can be used to configure the connectivity of the mesh such that the system is customized to that model. The model data does not change after training so a trained system can be deployed into such a system to provide an efficient means for executing the model while the same system can be configured for a different trained model by simply changing the connectivity mesh of the system. For example, an integrated circuit could be configured to accelerate inferences for different trained models by reconfiguring the configurable mesh of the integrated circuit for different trained models (e.g., in the same manner that multiple integrated circuits with the same underlying design can be programmed with different ROM values). In specific embodiments, approaches used for mask ROM can be used to configure the connectivity mesh of the system, such as by using different high level metal wiring masks that are customized to a specific model.

Modifying a system to be used for a specific model can essentially require saving the model in the mask ROM of the system.

In specific embodiments, the multipliers output digital or analog values that represent the output of the multiplication operations. The analog values can be represented by different reference voltages that extend from ground to the supply voltage. The digital values can be serialized pulse trains or any other type of digital encoding. The set of multipliers can include serializers. The read circuit for the set of readable cells can include a deserializer. The set of multipliers could be bit-serial multipliers. The read circuits for the set of readable cells could be coupled to bit-serial adders or multipliers. The digital signals can be transmitted to the readable cells continuously so that they are available to be read from those readable cells as soon as the cells are read. Alternatively, digital signals can be transmitted to the cells at the same time the cells are read to reduce the unnecessary transmission of signals through the connectivity mesh. For example, a read command for the readable cells could simultaneously trigger all the multipliers to output a serialized digital value to be transmitted through the connectivity mesh to the readable cells and then on to a reader.

In specific embodiments of the invention, the readable cells can be read in various ways. For example, a set of readable cells associated with a vector can be read in parallel to obtain the result of multiplying all the values in the vector by the input value in a single read operation. As another example, a set of readable cells associated with a vector can be read in parallel multiple times while different values are applied as the input value to obtain the result of multiplying all the values in the vector by those input values in a sequence of read operations. In specific embodiments, each set of outputs read from the set of readable cells can be applied to an accumulator which will accumulate the outputs obtained during that sequence of read operations. As another example, the set of readable cells can include subsets of cells associated with different vectors. The subsets of cells can be organized so that they can be read independently. For example, the set of readable cells can be configured like a memory array and the subsets of cells can each be associated with separate word lines such that all the values associated with that subset can be read in parallel.

In specific embodiments of the invention, a system is provided. The system comprises: a set of multipliers input-coupled to an input; a connectivity mesh; a set of readable cells wherein each readable cell in the set of readable cells is: (i) uniquely associated with a parameter of a vector, the parameter having a value; and (ii) coupled, via the connectivity mesh, to a multiplier, from the set of multipliers, that outputs a product of the value of the parameter and the input; and a read circuit that reads the product of the value of the parameter and the input from the set of readable cells.

In specific embodiments of the invention, a method is provided. The method comprises: providing a set of readable cells wherein each readable cell in the set of readable cells is uniquely associated with a parameter of a vector, the parameter having a value; and configuring a connectivity mesh such that each readable cell in the set of readable cells is coupled, via the connectivity mesh, to a multiplier, in a set of multipliers, that outputs a product of the value of the parameter and an input.

In specific embodiments of the invention, a method is provided. The method comprises: applying an input to a set of multipliers, wherein the set of multipliers are coupled to a set of readable cells using a connectivity mesh and each readable cell in the set of readable cells is: (i) uniquely associated with a parameter of a vector, the parameter having a value; and (ii) coupled, via the connectivity mesh, to a multiplier, from the set of multipliers, that outputs a product of the value of the parameter and the input; and reading, using a read circuit, the product of the value of the parameter and the input from the set of readable cells.

### BRIEF DESCRIPTION OF THE DRAWINGS

The accompanying drawings illustrate various embodiments of systems, methods, and other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a block diagram of an array of readable cells where a set of readable cells can be read in parallel in accordance with specific embodiments of the inventions disclosed herein.

FIG. 2 illustrates a block diagram of an array of readable cells that are coupled to a side table of values via a connectivity mesh in accordance with specific embodiments of the inventions disclosed herein.

FIG. 3 illustrates a block diagram of a system for matrix multiplication with an example input of “2” in accordance with specific embodiments of the inventions disclosed herein.

FIG. 4 illustrates an example layout of a readable cell and a portion of a connectivity mesh in accordance with specific embodiments of the inventions disclosed herein.

FIG. 5 illustrates programmed cells of a layout of readable cells and a portion of a connectivity mesh in accordance with specific embodiments of the inventions disclosed herein.

FIG. 6 illustrates a set of word lines and bit lines of programmed cells in accordance with specific embodiments of the inventions disclosed herein.

FIG. 7 illustrates a matrix multiplication in accordance with the related art.

FIG. 8 illustrates an alternative matrix multiplication in accordance with the related art.

FIG. 9 illustrates a matrix multiplication using a connectivity mesh.

FIG. 10 illustrates a process for accelerating matrix multiplication with multipliers having a single input in accordance with specific embodiments of the inventions disclosed herein.

FIG. 11 illustrates a process for accelerating matrix multiplication with multipliers having two inputs in accordance with specific embodiments of the inventions disclosed herein.

FIG. 12 illustrates a process for multiplying a vector by a row of readable cells in accordance with specific embodiments of the inventions disclosed herein.

FIG. 13 illustrates a process for multiplying a vector by two rows of readable cells, each row being associated with a different arrangement of connectivity mesh, in accordance with specific embodiments of the inventions disclosed herein.

FIG. 14 illustrates a process for multiplying a vector by multiple rows of readable cells and accumulating the results to produce an answer vector, in accordance with specific embodiments of the inventions disclosed herein.

FIG. 15 illustrates an example of multipliers designed to multiply an input by a fixed value in accordance with specific embodiments of the inventions disclosed herein.

FIG. 16 illustrates an example of a configurable connectivity mesh connecting the outputs of multipliers with corresponding readable cells in accordance with specific embodiments of the inventions disclosed herein.

FIG. 17 illustrates an example block diagram of a system performing accelerated matrix multiplication in accordance with specific embodiments of the inventions disclosed herein.

FIG. 18 illustrates an example of a method for accelerated matrix multiplication in accordance with specific embodiments of the inventions disclosed herein.

FIG. 19 illustrates an additional example of a method for accelerated matrix multiplication in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Methods and systems which involve computer architectures are disclosed in detail herein. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

In specific embodiments of the invention, a system is provided. The system comprises a set of multipliers input-coupled to an input, a connectivity mesh, and a set of readable cells. Each readable cell in the set of readable cells is: (i) uniquely associated with a parameter of a vector, the parameter having a value; and (ii) coupled, via the connectivity mesh, to a multiplier, from the set of multipliers, that outputs the product of the value of the parameter and the input. The system may also comprise a read circuit that reads a product of the input and the vector from the set of readable cells. The system can be implemented in circuitry. The system can be implemented as an integrated circuit or one or more integrated circuits that are in communication with each other. The system can be a matrix multiplication accelerator. The system can include a controller such as a central processing unit, microcontroller, control circuit, or other controller that is capable of feeding operands to the matrix multiplication accelerator in order to accelerate computations involving large matrices.

In specific embodiments, systems in accordance with the system described in the prior paragraph can be used to accelerate a computation involving an input and a vector. In a first set of embodiments, the input can be a scalar value. The set of multipliers can each receive the scalar as an input and different values of the parameters of the vector as operand inputs. The multipliers are input-coupled to the input and the different values in that those values are delivered to the multiplier in order for the multiplier to execute a multiplication using those values as operands. The different values of the parameters of the vector that are received by the multipliers can be all the potential values of the parameters of the vector. Alternatively, in a second set of embodiments, the set of multipliers can each receive the scalar as an input and be configured to multiply the input by a fixed value to output the product of the scalar times that fixed value. The fixed values can be all of the potential values of the parameters of the vector. In a second set of embodiments, the input can also be a vector, and a controller can be configured to provide the independent scalar values of the vector to the multiplier in sequence.

In specific embodiments, the same systems can be part of larger systems that are used to accelerate computation involve matrices as will be described below. In these embodiments, the set of readable cells can be organized in rows and columns with each cell being uniquely associated with a parameter of the matrix. In these embodiments, a controller circuit can provide multiple input values to the set of multipliers, read the resulting output values using the read circuits and accumulate the output values in specific patterns to produce the result of a matrix multiplication. The controller circuit can be configured to read certain subsets of the readable cells in a particular order to obtain the result of a matrix multiplication.

In specific implementations, the number of readable cells will be equivalent to the number of parameters in a neural network matrix (e.g., the number of readable cells in an integrated circuit implementation can be on the giga-scale where the readable cells are uniquely associated with billions of parameters). The set of readable cells and the parameters are associated in a one-to-one correspondence and the set of readable cells are ordered to match the order of the parameters in the vector. Notably, the readable cells are not associated directly with the values for the parameters but are instead associated with the parameters themselves. In other words, the readable cells are each associated with an entry of the vector and are ordered to match the order of those entries.

The cardinality of the set of multipliers can be set to different values in different applications. In specific embodiments, the set of multipliers can be associated with every value in a vector in a one-to-one correspondence. For example, if the parameters were represented by a 4-bit data type there would be a set of 16 multipliers (a multiplier for each unique value of the parameter), and if the parameters were represented by a 16-bit data type there would be a set of 65,536 multipliers. In specific embodiments, the parameters in a vector are n-bit values and the set of multipliers has a cardinality of two to the n power.

The multiplier inputs can be provided in various ways in different applications. The multiplier inputs can be a set of fixed inputs and an input value. The set of fixed inputs can be the values of the parameters in the vector that will be multiplied, and the input value can be the value that the vector will be multiplied by. The input value can be provided by a controller. The set of fixed inputs can be hard coded into the circuitry of the system in various ways (such that the input value is the only true input to the multiplier). The voltage or current between zero and supply could be divided into a large number of values to represent multibit values. The set of multipliers can accordingly output a set of analog reference voltage or currents to the set of readable cells through the connectivity mesh. The multipliers can be bit serial multipliers, and the read circuits can be coupled to adders or accumulators that are also configured for bit serial operation.

The multipliers can include ancillary circuitry in addition to the circuitry that conducts the multiplication of the operands in different applications. In specific embodiments, the set of multipliers can include a set of serializers to serialize the output values for transmission through the connectivity mesh to the readable cells. In these embodiments, the read circuits that are configured to read the readable cells can include a set of deserializers to resolve the values after reading them from the readable cells. In specific embodiments, the set of multipliers can include a set of amplifiers to amplify the output values for transmission through the connectivity mesh. The amplifiers, serializers, or amplifiers and serializers can be trimmed to provide the appropriate degree of amplification based on the number of readable cells connected to a given multiplier to optimize power consumption. For example, a multiplier connected to a small number of readable cells can have low amplification and power consumption to minimize power consumption while a multiplier connected to many readable cells can have high amplification and higher power consumption to meet speed requirements. The trimming can be done in a calibration step in which the load on each multiplier is determined. This trimming may improve efficiency and power consumption of the system.

The connectivity mesh can take on various characteristics in different applications. The connectivity mesh can connect the outputs of the set of multipliers to the set of readable cells. The connectivity mesh can connect the output of a multiplier, that is associated with a given parameter value by having that parameter value as an input, to a set of readable cells that are all associated with parameters having that given parameter value. For example, the multiplier could have a fixed input value of 5 and the connectivity mesh could connect the output of the multiplier to every readable cell associated with a parameter having a value 5. The connectivity mesh can have various fan outs from the multipliers based on the number of parameters in a vector that have the various values associated with those multipliers. In specific embodiments, the connectivity mesh can be configurable. The connectivity mesh can be configurable when the system is operational, when the system is being fabricated, or during back-end processing.

The readable cells can take on various characteristics in different applications. In specific embodiments, the set of readable cells are configured to be read so that the multiplied output values of a vector can be read in parallel and resolved by a higher-level system. The readable cells can each be associated with a parameter value from a vector. Sets of readable cells may represent a vector or matrix. The individual readable cells can be configured in various ways in different applications. In specific embodiments, the readable cells can be configured similarly to ROM cells. In specific embodiments, the readable cells can consist essentially of an access transistor. In specific embodiments of the invention, the set of readable cells can be addressable by a read circuit. The read circuit can read the output values for a given vector multiplication in parallel.

In specific embodiments of the invention, an accumulator or parallel adder can be coupled to a read circuit. As the read circuit reads the product of an input value and a vector associated with the readable cells, the accumulator can accumulate the product with a stored value. In this way, matrix multiplication can be facilitated by conducting the multiply-accumulate operations as the readable cells are read in sequence and the resulting product values are accumulated in the accumulator. The parallel adder can be a large adder that can take in the output vectors from several subsets of readable cells and add the values together in parallel. The system may be configured to do the multiply and accumulate steps for a matrix multiplication in a single clock cycle.

The matrix associated with the readable cells can include the model data of a machine intelligence model such that the values don't change, and the system is configured to compute inferences using that specific model. Given that, in specific embodiments, the connectivity mesh is configured using back end of line masks such as masks for top level metal, the resulting system provides an accelerator for machine intelligence models generally that can be customized for a specific machine intelligence model at relatively low expense. This is because the cost of masks for fabricating different higher level metal layers can be a factor of 10-100 less than the cost of masks for the underlying circuitry.

In specific machine intelligence applications, the matrix associated with the readable cells mentioned in the prior paragraph may be extremely large in one dimension and be relatively small in a second dimension (e.g., the second dimension is set by the input to the layer). As a result, systems in accordance with this disclosure can beneficially be applied to machine intelligence applications because the second dimension sets the number of read operations that must be conducted which impact the time it takes to conduct the computation while the first dimension sets the size of the set of readable cells. Given that the set of readable cells can consist essentially of a single basic access transistor, this large first dimension can be made very high for low cost. As such, the resulting system can conduct machine intelligence matrix computations at high speed and low cost.

In specific embodiments of the invention, methods for configuring a system for matrix multiplication acceleration are provided. The methods comprise providing a set of readable cells wherein each readable cell in the set of readable cells is uniquely associated with a parameter of a vector, the parameter having a value. The methods also comprise configuring a connectivity mesh such that each readable cell in the set of readable cells is coupled, via the connectivity mesh, to a multiplier, in a set of multipliers, that outputs the product of the value of the parameter and the input. In specific embodiments, each readable cell in the set of readable cells may be coupled, via the conductivity mesh, to a multiplier in the set of multipliers that is input-coupled to a value of the parameter. The methods for configuring the system for matrix multiplication acceleration can be continued with steps for using the system for matrix multiplication acceleration. These steps can include applying an input to the set of multipliers and reading, using a read circuit, a product of the input and the vector from the set of readable cells.

In specific embodiments of the invention, methods for using a system for matrix multiplication acceleration are provided. The methods comprise applying an input to a set of multipliers. The set of multipliers are coupled to a set of readable cells using a connectivity mesh and each readable cell in the set of readable cells is: uniquely associated with a parameter of a vector, the parameter having a value; and coupled, via the connectivity mesh, to a multiplier, from the set of multipliers, that outputs the product of the value of the parameter and the input. The methods also comprise reading, using a read circuit, a product of the input and the vector from the set of readable cells. The methods for using the system for matrix multiplication acceleration can be preceded by steps for configuring the system for matrix multiplication acceleration. These steps can include configuring, prior to applying the input, the connectivity mesh such that each readable cell in the set of readable cells is coupled, via the connectivity mesh, to the multiplier, in the set of multipliers, that is input-coupled to the value of the parameter.

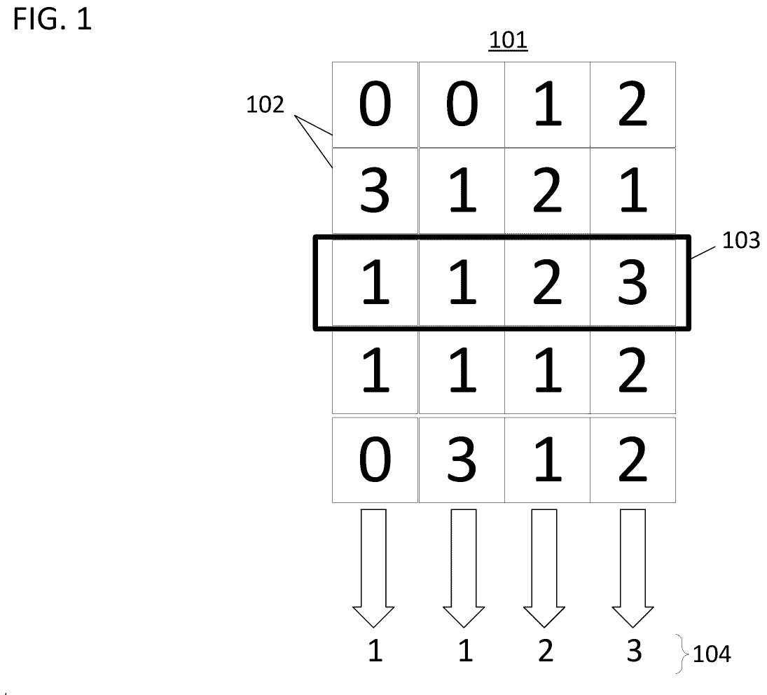

FIG. 1 illustrates a block diagram of array 101 of readable cells 102 where a set of readable cells can be read in parallel. In the illustrated example, the third row 103 of array 101 is being read and all the associated values are being read out of the cells in parallel. In accordance with specific embodiments of the invention, a set of readable cells can be associated with parameters in a matrix. In the illustrated case, readable cells 102 are associated with a set of parameters of a 5:4 matrix where each readable cell 102 stores the value of the associated parameter. In FIG. 1, each of the readable cells 102 is labeled with the value of the associated parameter as stored by the associated readable cell. Output 104 indicates that third row 103 reads as “1 1 2 3.”

In specific embodiments, array 101 may include model data of a machine intelligence model. This data may be part of a matrix multiplication operation using an input and a vector. In specific embodiments, systems in accordance with the present disclosure can be used to accelerate a computation involving an input and a vector. In a first set of embodiments, the input can be a scalar value. A set of multipliers can each receive the scalar as an input and different values of the parameters of the vector as operand inputs. The multipliers may be input-coupled to the input and the different values in that those values are delivered to the multiplier in order for the multiplier to execute a multiplication using those values as operands. The different values of the parameters of the vector that are received by the multipliers can be all the potential values of the parameters of the vector. Alternatively, the set of multipliers can each receive the scalar as an input and be configured to multiply the input by a fixed value to output the product of the scalar times that fixed value. The fixed values can be all of the potential values of the parameters of the vector. In a second set of embodiments, the input can also be a vector, and a controller can be configured to provide the independent scalar values of the vector to the multiplier in sequence.

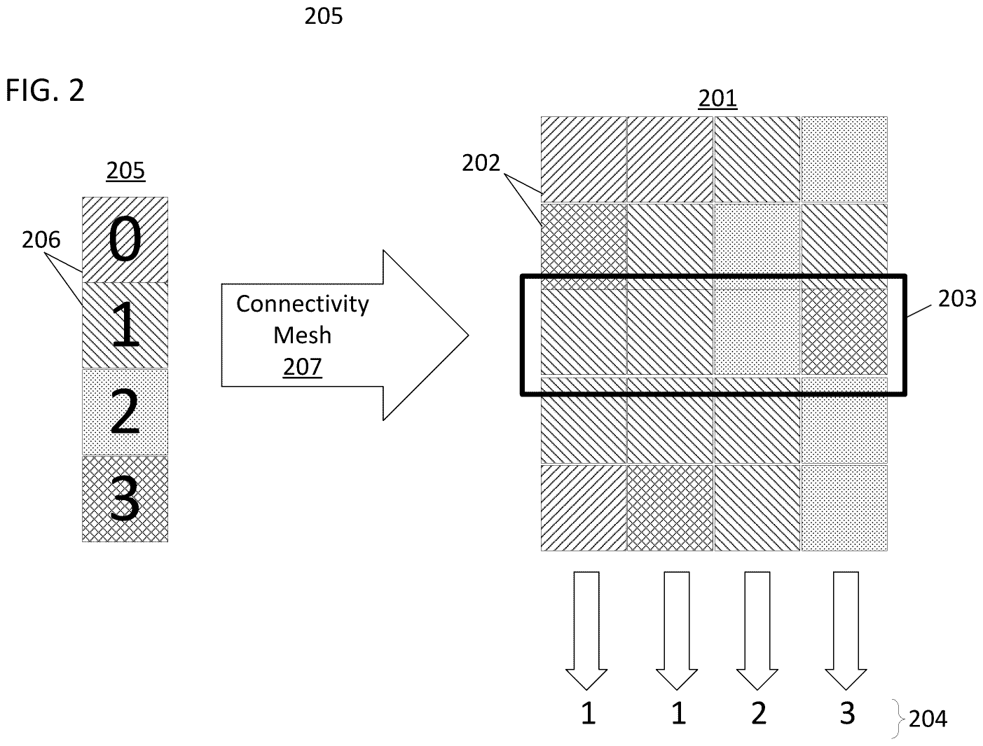

FIG. 2 illustrates how side table 205 of values 206 can be used to produce the same informational content as the array in FIG. 1 (e.g., output 204 is the same as output 104). FIG. 2 illustrates a block diagram of array 201 of readable cells 202 where a set of readable cells 202 can be read in parallel. Array 201 contains the same values for readable cells 202 as array 101 contains for readable cells 102. In the illustrated example, the third row 203 of array 201 is being read and all the associated values are being read out of the cells in parallel. In this case, side table 205 includes a set of values 206 equal to every potential value of the parameters in the matrix (e.g., every possible value for readable cells 202). The set of values 206 comprises the values 0, 1, 2, and 3. Side table 205 is then connected to readable cells 202 using connectivity mesh 207 such that values 206 are connected to the readable cells 202 that are associated with the matrix parameters having those values. Accordingly, when readable cells 202 corresponding to the same parameters are read, the same values 206 are read out of array 201, via connectivity mesh 207 connecting readable cells 202 to their corresponding values 206. Using this approach, side table 205 can be replaced with a set of multipliers where the multipliers are connected to an input equal to the illustrated potential values of the parameters in the matrix, and another input that can be used as an input to the system to produce a multiplication of the entire matrix via the routing of the values to the array via connectivity mesh 207. In specific examples, the multipliers are connected to the input that can be used as an input to the system while the illustrated potential values of the parameters are hardcoded (e.g., not input).

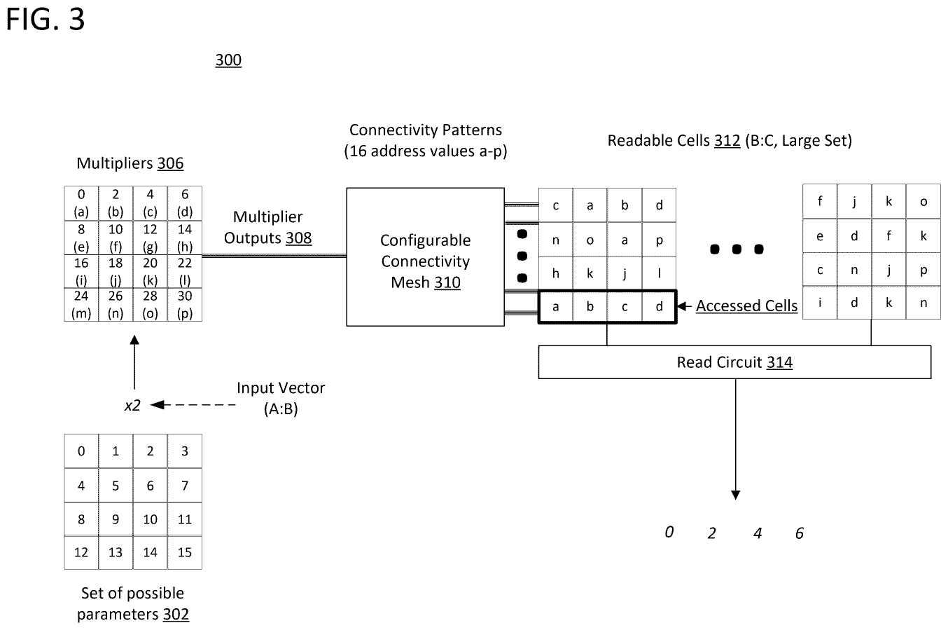

FIG. 3 illustrates a block diagram of system 300 for matrix multiplication including set of multipliers 306, connectivity mesh 310, and array of readable cells 312. Connectivity mesh 310 may be configurable. Array of readable cells 312 may contain a large set of values. In the illustrated example, a portion of the fourth row of array of readable cells 312 is being accessed (e.g., read) and all the associated values are being read out of the cells in parallel. In accordance with specific embodiments of the invention, the array of readable cells 312 may be associated with parameters in a matrix or vector. Set of possible parameters 302 may be used to multiply array of readable cells 312 by another matrix, vector, or scalar. Set of possible parameters 302 may be a set, array, list, or other organization of data, or may be hardcoded into multipliers 306. In the example of FIG. 3, at least a portion of array of readable cells 312 is multiplied by a factor of two. This factor of two may be part of an input vector where system 300 is calculating the result of the input vector multiplied by the parameter matrix (e.g., via array of readable cells 312).

Also in this example, system 300 (e.g., an accelerator architecture of the machine learning system) may utilize 4-bit data types, which can be used to represent at most 16 different values. Accordingly, set of possible parameters 302 includes a set of values equal to every potential value of the parameters in the matrix, values 0-15. Set of possible parameters 302 is then multiplied by two (e.g., from the input vector) via set of multipliers 306 to create a set of multiplier outputs 308. Set of multipliers 306 may be connected to array of readable cells 312 using connectivity mesh 310 such that the values of set of multipliers 306 are connected to the readable cells in array of readable cells 312 that are associated with the matrix parameters having those values. Accordingly, multiplier outputs 308 are input into corresponding cells of array of readable cells 312. For example, each cell with a value “a” in the array of readable cells may be connected to the corresponding “a” in set of multipliers 306. Each cell with a value “b” in the array of readable cells may be connected to the corresponding “b” in set of multipliers 306, etc. The multipliers of set of multipliers 306 are connected to an input equal to the illustrated potential values of the parameters in the matrix (e.g., set of possible parameters 302), and another input (e.g., from the input vector) that can be used to produce a multiplication of the entire matrix (e.g., of which the input vector is a part) via the routing of the potential values of the parameters to array of readable cells 312 via connectivity mesh 310. Connectivity mesh 310 can take on various characteristics in different applications. Connectivity mesh 310 can comprise a mesh of wires and vias in the metal or wiring layers of one or more integrated circuits. Connectivity mesh 310 can comprise conductive connections for optical or electronic signals. Connectivity mesh 310 can have various fan outs from multipliers in set of multipliers 306 based on the number of parameters in a vector that have the various values associated with those multipliers 306.

When a value of array of readable cells 312 is read, the corresponding value of set of multipliers 306 is read. For example, the value “a” of array of readable cells 312 will read out “0” (which corresponds to the value “a” in set of multipliers 306). The value “b” of array of readable cells 312 will read out “2” (which corresponds to the value “b” in set of multipliers 306). The value “c” of array of readable cells 312 will read out “4” (which corresponds to the value “c” in set of multipliers 306). The value “d” of array of readable cells 312 will read out “6” (which corresponds to the value “d” in array of multipliers 306). Accordingly, as the values “a b c d” are accessed from array of readable cells 312, read circuit 314 outputs “0 2 4 6.” In another example, if the cells “i d k n” were to be accessed from array of readable cells 312, then read circuit 314 would output “16 6 20 26.”

System 300 reduces the number of discrete multiplication operations performed when multiplying a matrix. As illustrated, there are 16 possible values for the cells in array of readable cell 312. If a row of the parameter matrix were to be multiplied by two, then each cell of a row of array of readable cells 312 would need to be multiplied by two. If each cell of array of readable cells 312 were multiplied by two directly, a large amount of multiplication operations would be performed. For example, if array of readable cells 312 contains 48 cells in a row, then there would be 48 multiplication operations. Rather than multiply each cell in the row of array of readable cells 312, each possible value of array of readable cells 312 is multiplied by two via set of multipliers 306, which then may be referenced as the corresponding row of array of readable cells 312 is read. As there are only 16 possible values for the readable cells, only 16 multiplications are performed. 16 multiplication operations may be performed much faster than 48 multiplication operations, and this benefit increases as the size of array of readable cells 312 increases.

The cardinality of the set of multipliers 306 can be set to different values in different applications. In specific embodiments, the set of multipliers can be associated with every value in a vector in a one-to-one correspondence. For example, in a vector with 1,000 parameters and 57 unique values, the set of multipliers could be a set of 57 multipliers with each multiplier associated uniquely with one of the 57 unique values. In specific embodiments, the set of multipliers can be associated with every potential value of a parameter in the vector (e.g., similar to set of possible parameters 302). For example, in a vector with 1 trillion parameters where each parameter could be one of 50,000 unique values, the set of multipliers could be a set of 50,000 multipliers with each multiplier associated uniquely with one of the 50,000 unique values. In specific embodiments, the set of multipliers will include a multiplier for every potential value of the parameters as set by the resolution of the data type used to represent the parameters. For example, if the parameters were represented by a 4-bit data type there would be a set of 16 multipliers, and if the parameters were represented by a 16-bit data type there would be a set of 65,536 multipliers. In specific embodiments, the parameters in a vector are n-bit values and the set of multipliers has a cardinality of two to the n power.

Array of readable cells 312 may be associated with model data of a machine intelligence model such that the values don't change, and the system is configured to compute inferences using that specific model. Given that, in specific embodiments, connectivity mesh 310 may be configured using back end of line masks such as masks for top level metal. The resulting system provides an accelerator for machine intelligence models generally that can be customized for a specific machine intelligence model at relatively low expense. This is because the cost of masks for fabricating different higher level metal layers can be a factor of 10-100 less than the cost of masks for the underlying circuitry.

In specific machine intelligence applications, array of readable cells 312 may have an extremely large C value and a B value that is set by the input to the layer, which is usually kept relatively low. As a result, systems in accordance with this disclosure that use the multiplication processes described in the prior paragraphs can beneficially be applied to machine intelligence applications because the B value sets the number of read operations that must be conducted which impact the time it takes to conduct the computation while the C value sets the size of the set of readable cells. Given that the set of readable cells can consist essentially of a single basic access transistor, this value can be made very high for low cost. As such, the resulting system can conduct machine intelligence matrix computations at high speed and low cost.

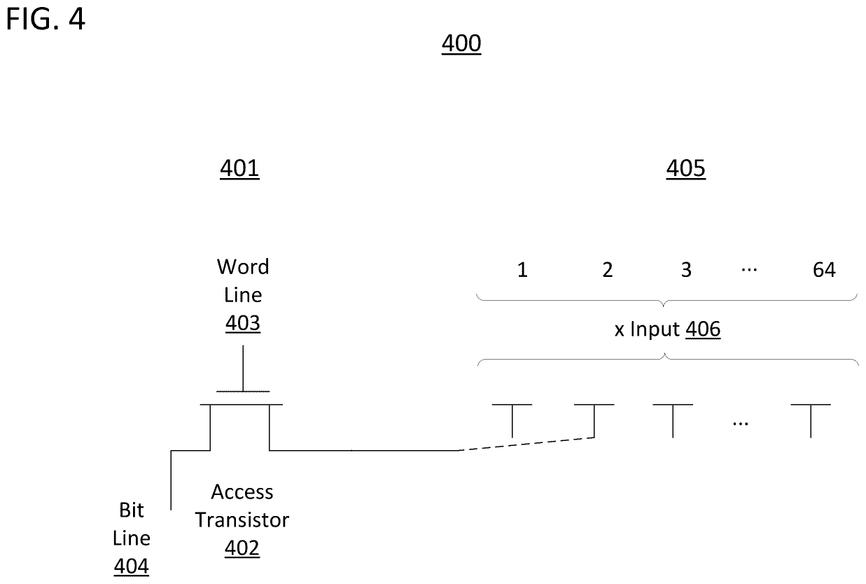

FIG. 4 illustrates an example implementation of readable cell 401 and connectivity mesh 405 in system 400. Readable cell 401 consists essentially of access transistor 402 with a gate connected to word line 403 and a source connected to bit line 404. The drain of access transistor 402 is connected to connectivity mesh 405. As illustrated, connectivity mesh 405 has been configured so that readable cell 401 is associated with the value 2. As a result, when bit line 404 and word line 403 of access transistor 402 is activated, the value that is read from readable cell 401 will be the value 2 multiplied (via a multiplier) by the value of input 406 to system 400. Word line 403 can be activated by sending a supply voltage signal to access transistor 402 and bit line 404 can be selected by activating a read circuit connected to bit line 404.

In specific embodiments, system 400 can be part of larger systems that are used to accelerate computations involving matrices. In these embodiments, a set of readable cells 401 can be organized in rows and columns with each readable cell 401 being uniquely associated with a parameter of a matrix. In these embodiments, a controller circuit can provide multiple values of inputs 406 to a set of multipliers, read the resulting output values using read circuits and accumulate the output values in specific patterns to produce the result of a matrix multiplication. The controller circuit can be configured to read certain subsets of readable cells 401 in a particular order to obtain the result of a matrix multiplication.

Readable cells 401 can take on various characteristics in different applications. In specific embodiments, a set of readable cells 401 are configured to be read so that the multiplied output values of a vector can be read in parallel and resolved by a higher-level system. The higher-level system will logically link the application of a particular input value to the set of multipliers with the output values read from readable cells 401. Readable cells 401 can each be associated with a parameter value from a vector. Readable cells 401 can be gathered in subsets of readable cells where the subset of readable cells represents an entire vector. The subsets of readable cells can be part of a larger set of readable cells that represents an entire matrix. Readable cells 401 can be part of a set of readable cells that defines all the available readable cells in a given integrated circuit or block of circuitry in a given integrated circuit. For example, a given block of circuitry could include an array of readable cells 401 that is 1 billion readable cells by 1,000 readable cells in order to store a matrix having a trillion parameters. Readable cells 401 can be distributed in various layouts relative to the set of multipliers. In specific embodiments, the set of multipliers can be placed towards the center of a large set of readable cells so that connectivity mesh 405 can spread out from the center of the block in multiple directions to minimize overlap of routing.

Individual readable cells 401 can be configured in various ways in different applications. In specific embodiments, readable cells 401 can be configured similarly to ROM cells. In specific embodiments, a readable cell 401 can consist essentially of access transistor 402. When access transistor 402 is conductive, the value that is routed from the multipliers to readable cell 401 via connectivity mesh 405 can be passed through access transistor 402 and read out by a read circuit. When access transistor 402 is not-conductive, the same read circuit can be used to read a different value. The control node of access transistor 402 can be connected to word line 403. A drain or source node of access transistor 402 can be coupled to connectivity mesh 405 and receive the output signal from the multiplier. The alternative drain or source node of access transistor 402 can be coupled to bit line 404. Bit line 404 can be connected to a read circuit. Readable cell 401 can be read by activating word line 403 and bit line 404.

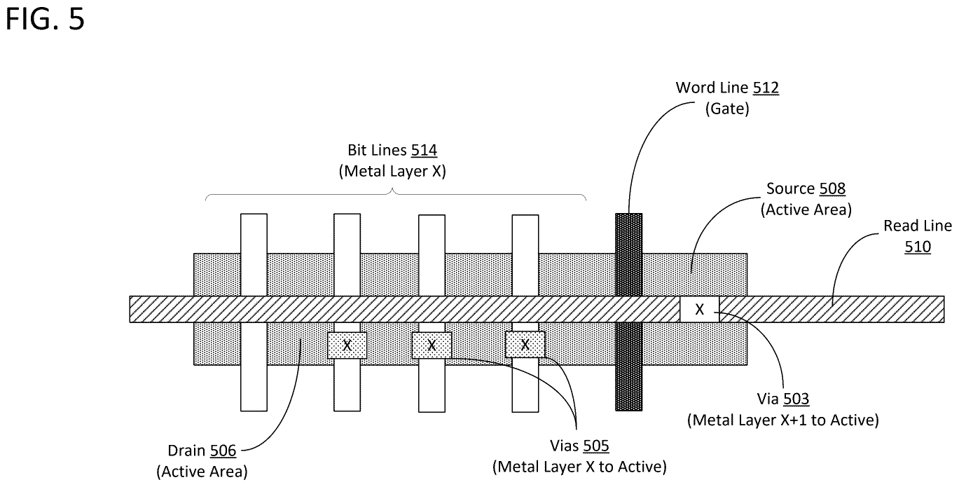

FIG. 5 illustrates five programmed cells (e.g., of a ROM) that are in accordance with specific embodiments of the inventions disclosed herein. The five programmed cells are all formed by the same transistor. The transistor includes drain 506 in a region of the substrate that has been doped to serve as the active area of a transistor. Drain 506 (e.g., drain region) serves as the bit terminal of the transistor. The transistor also includes source 508 in a region of the substrate that has been doped to serve as the active area of the transistor. Source 508 (e.g., source region) serves as the read terminal of the transistor and is connected to read line 510 of the ROM memory by via 503. The transistor also includes a gate (e.g., coupled to word line 512) which can be a strip of doped polysilicon or other conductive material over a channel of the transistor.

The transistor in FIG. 5 has been programmed through the programmatic formation of vias 505 that connect bit lines 514 to the bit terminal. In the illustrated case, vias 505 are metal one vias that connect the lowest layer of metal, which forms bit lines 514, to the active area of the transistor. As illustrated, three of the four bit lines 514 have been connected to the active area through the introduction of vias 505 at the intersection of the bit lines and the bit terminal while a fourth bit line has not been connected to the active area through the introduction of a via at that intersection. Vias 505 in FIG. 5 are illustrated as being off center of the active area for clarity. However, vias 505 can be placed in the center of the active area directly below read line 510 since read line 510 can be a metal two layer of metal which can be routed over the metal one layer and its vias (e.g., including vias 505). In general, read line 510 can be any higher layer of metal than metal one in order to accommodate this configuration so long as the metal layers below it do not interfere with via 503 to the read terminal of the transistor.

Reading a cell from a transistor of a ROM as pictured in FIG. 5 involves activating word line 512 and a bit line of the set of bit lines 514. The voltage required to activate word line 512 will depend on the polarity and characteristics of the transistor. However, regardless of the voltage required, activating word line 512 will result in the formation of a conductive path through the channel of the transistor such that the bit terminal is coupled to the read terminal. The voltage required to activate the bit line (bit line 514 corresponding to the read cell) will likewise depend on the polarity and characteristics of the transistor and will also depend on the characteristics of the read circuit.

The read circuit characteristics will impact what voltage is required to activate one of the bit lines 514. For example, activating one of the bit lines 514 may involve creating a current sink to pull charge off read line 510 through the connection to the bit line by lowering the voltage on the bit line. In these embodiments, when the voltage on read line 510 does not drop in response to reading the cell, the read circuit will be able to determine that no connection was formed between the bit line and the active area and will thereby read a first value from memory. However, when the voltage on read line 510 does drop in response to reading the cell, the read circuit will be able to tell that there was a connection formed between the bit line and the active area and will thereby read a second value from memory. As another example, activating one of the bit lines 514 may involve creating a current source to push charge onto read line 510 through the connection to the bit line by increasing the voltage on the bit line. In these embodiments, when the voltage on read line 510 does not rise in response to reading the cell, the read circuit will be able to determine that no connection was formed between the bit line and the active area and will thereby read a first value from memory. However, when the voltage on read line 510 does rise in response to reading the cell, the read circuit will be able to tell that there was a connection formed between the bit line and the active area and will thereby read a second value from memory. In embodiments in which the cells are multivalue, the final voltage or time it takes to change the voltage on read line 510 can indicate the conductivity of the connection to the bit line to thereby read a multivalue value from memory.

In specific embodiments, transistors (e.g., similar to the transistor of FIG. 5 or access transistor 402 of FIG. 4) can be arranged in an array to form a ROM memory. The individual cells of the memory can be addressed by activating a specific combination of a word line and bit line. In specific embodiments, the transistors and conductive lines that form the memory cells disclosed herein can be the same kinds of transistors and conductive lines used for any logic circuitry that may be implemented on the same substrate. Accordingly, no extra processing steps are required to support specific embodiments of the ROMs disclosed herein. Instead, the masks used to form the bit terminal can be adjusted to account for the increased size of the transistors that form the RAM while keeping all other processing steps the same. In alternative approaches, an additional processing step, or set of steps, can be utilized to account for the larger dimensions of the bit terminal such as by modifying the dose of the dopants used to form the bit terminal as compared to the corresponding terminals of the transistors in the logic circuitry of the same substrate.

The readable cells depicted in FIG. 5 may take on various characteristics in different applications. In specific embodiments, a set of readable cells are configured to be read so that the multiplied output values of a vector can be read in parallel and resolved by a higher-level system. The higher-level system will logically link the application of a particular input value to the set of multipliers with the output values read from the readable cells. The readable cells can each be associated with a parameter value from a vector. The readable cells can be gathered in subsets of readable cells where the subset of readable cells represent an entire vector. The subsets of readable cells can be part of a larger set of readable cells that represents an entire matrix. The readable cells can be part of a set of readable cells that defines all the available readable cells in a given integrated circuit or block of circuitry in a given integrated circuit. For example, a given block of circuitry could include an array of readable cells (e.g., will cells similar to those of FIG. 5) that is 1 billion readable cells by 1,000 readable cells in order to store a matrix having a trillion parameters. The readable cells can be distributed in various layouts relative to the set of multipliers. In specific embodiments, the set of multipliers can be placed towards the center of a large set of readable cells so that the connectivity mesh can spread out from the center of the block in multiple directions to minimize overlap of routing. The individual readable cells can be configured in various ways in different applications. In specific embodiments, the readable cells can be configured similarly to ROM cells.

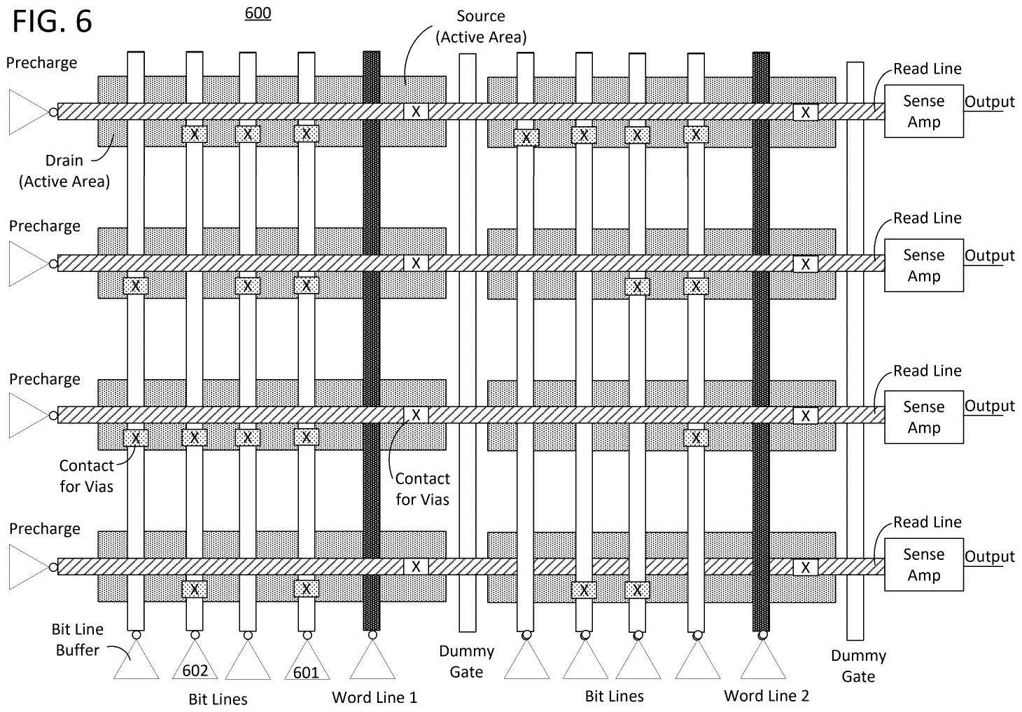

In specific embodiments, FIG. 5 may make up a portion of an array of readable cells or a portion of a connectivity mesh (see, for example, FIG. 6). For example, the transistor (e.g., access transistor) may act as a switch. The switch may connect an output of a set of multipliers to the set of readable cells. The switch may be configurable when the system is deployed. For example, the switch may be controlled through the delivery of control signals to the control nodes of the switches when the system has been fabricated and powered on. Alternatively, the switches can be configurable when the system is being fabricated. The state of the switches can be set using similar approaches to those used to store values in read only memory (ROM). The switches may be transistors or other forms of hardware. The state of the switches can be set through the controlled delivery of dopants to activate specific transistors, through the use of customized layouts for the wiring layers of the device, or through the use of fuse or anti-fuses to make or break connections between different circuit nodes.

The configurability of the connectivity mesh can allow the system to serve as a computational structure for specific matrices. For example, in machine intelligence applications, the model data of a machine intelligence application can be used to configure the connectivity of the mesh such that the system is customized to that model. The model data does not change after training so a trained system can be deployed into such a system to provide an efficient means for executing the model while the same system can be configured for a different trained model by simply changing the connectivity mesh of the system. For example, an integrated circuit could be configured to accelerate inferences for different trained models by reconfiguring the configurable mesh of the integrated circuit for different trained models (e.g., in the same manner that multiple integrated circuits with the same underlying design can be programmed with different ROM values). In specific embodiments, approaches used for mask ROM can be used to configure the connectivity mesh of the system, such as by using different high level metal wiring masks that are customized to a specific model. Modifying a system to be used for a specific model can essentially require saving the model in the mask ROM of the system.

FIG. 6 illustrates a set of word lines and bit lines of programmed (e.g., readable) cells as part of system 600 that is in accordance with specific embodiments of the inventions disclosed herein. System 600 may include a section of a ROM with eight transistors that are in accordance with the transistor and cells of FIG. 5. As illustrated, the different transistors have been programmed and have different patterns of connections between the bit lines and the bit terminal of the transistors. The figure also illustrates how columns of transistors share the same conductive lines for bit lines and the same conductive line for their gates. Furthermore, the figure shows how the inter-row spacing of the array is limited only by the minimum allowed distance between adjacent source and drain regions of different transistors which is a small distance in modern processors. The figure also shows how different columns of the ROM can be separated by dummy gates and source and drain regions of adjacent columns are placed in close proximity to each other.

The illustrated set of readable cells of system 600 includes rectangles of active semiconductor material that form the channels, sources, and drains of the access transistors. The set of readable cells also includes vertical lines with diffusion breaks (dummy gates) between adjacent columns to isolate adjacent strips of access transistors, vertical lines (e.g., of a lowest layer of metal) that are word lines for the readable cells, and horizontal lines that are bit lines (e.g., on a second layer of metal). As illustrated, the bit line contacts are shared by multiple readable cells as the “x” elements illustrate contacts for vias (e.g., between the metal and the semiconductor material in which the access transistors are formed). Also as illustrated, the word lines serve to modulate the channel of the access transistor between a conductive and a non-conductive state.

The set of readable cells of system 600 may be connected to a set of multipliers via a connectivity mesh. The connectivity mesh may be a set of metal layers that can be used for the various values that will be routed to the access transistors. In specific embodiments, connecting a specific value to the access transistor involves adding a jog and a stack of vias from the metal associated with the desired value to the drain via contact of the access transistors. The connectivity mesh (e.g., grid) can be configured so that the number of potential values that can be connected to a given access transistor is equal to the number of metal layers above the lowest two metal layers multiplied by the number of strips of metal that can be laid over the readable cell while leaving room for jogs from any of the strips.

In operation, the ROM in FIG. 6 may operate by pre-charging the read lines using the illustrated pre-charge buffers. The read lines can be pre-charged to a high, low, or tri-state value depending upon the characteristics of the ROM. Subsequently, a combination of a word line and bit line can be activated. A set of four values can then be read from a column of the ROM associated with the activated word line. The bit lines will either move charge to or from the read line or will not move charge to or from the read line depending upon the state of the cell (i.e., whether a connection was formed between the bit line and the bit terminal for the activated cell). The voltage on the read lines can be monitored by sense amplifiers which will, after the read period, provide an output value on the illustrated output lines. The number of values that can be simultaneously read is thereby only limited by the number of sense amplifiers available and the number of transistors in a column which are connected to those sense amplifiers.

The connections between the bit line and bit terminals can include diodes. The diodes can be used to prevent charge moving through the connection to a bit line that is not activated. For example, with reference to FIG. 6, if the bit line associated with bit line buffer 601 was activated by bringing the bit line high, and the transistor was an n-type transistor with the drain as the bit terminal, care must be taken to assure that current does not leak out through the connection to the bit line associated with bit line buffer 602. As such, the connections can include diodes that only allow current to flow to or from the bit terminal when the associated bit line is activated. The threshold voltage of the diode could be set high enough to prevent leakage while still being far less than the differential voltage formed across the diode when the bit line was activated. In the case of the n-type transistor mentioned above with an activated bit line at a high value, the transistors could be pn-junction transistors with the n-type material on the bit terminal side of the junction and the p-type material on the bit line side of the junction.

In specific embodiments of the invention, the set of readable cells of system 600 can be addressable by a read circuit. The read circuit can then be used to retrieve the output values associated with the multiplication of a given vector from the readable cells. The read circuit can address a given subset of readable cells to read the output values for a given vector multiplication in parallel. The read circuit can be configured to read the same set of readable cells later when a different input value has been provided to the multiplier or a different set of readable cells later when the same input value has been provided to the multiplier to obtain the results of a variety of scalar-vector multiplications. The read circuit can be configured to read a first subset of the set of readable cells associated with a first word line independently, and a second subset of the set of readable cells associated with a second word line independently. The way the read circuit is configured to do so can be like the approaches used in standard ROM, RAM, or flash memories in which different sets of memory cells are commonly connected to a word line and can be read in parallel or individually with the assistance of a bit line selection.

In specific embodiments of the invention, system 600 can include an accumulator. The accumulator can be coupled to a read circuit. As the read circuit reads the product of an input value and a vector associated with the readable cells, the accumulator can accumulate the product with a stored value. In this way, matrix multiplication can be facilitated by conducting the multiply-accumulate operations as the readable cells are read in sequence and the resulting product values are accumulated in the accumulator. In specific embodiments of the invention, system 600 can include multiple read circuits and accumulators so that a specific input can be multiplied by separate vectors simultaneously.

The readable cells in system 600 can include the model data of a machine intelligence model such that the values don't change and system 600 is configured to compute inferences using that specific model. The readable cells in system 600 may also be coupled with a set of multipliers via a connectivity mesh. Given that, in specific embodiments, the connectivity mesh is configured using back end of line masks such as masks for top level metal the resulting system provides an accelerator for machine intelligence models generally that can be customized for a specific machine intelligence model at relatively low expense. This is because the cost of masks for fabricating different higher level metal layers can be a factor of 10-100 less than the cost of masks for the underlying circuitry.

In specific machine intelligence applications, the readable cells of system 600 are associated with a matrix having dimensions B:C. In specific embodiments, the matrix has an extremely large C value and a B value that is set by the input to the layer, which is usually kept relatively low. As a result, system 600, when performing matrix multiplication as described herein, can beneficially be applied to machine intelligence applications because the B value sets the number of read operations that must be conducted which impact the time it takes to conduct the computation while the C value sets the size of the set of readable cells. Given that the set of readable cells can consist essentially of a single basic access transistor, this value can be made very high for low cost. As such, the resulting system can conduct machine intelligence matrix computations at high speed and low cost.

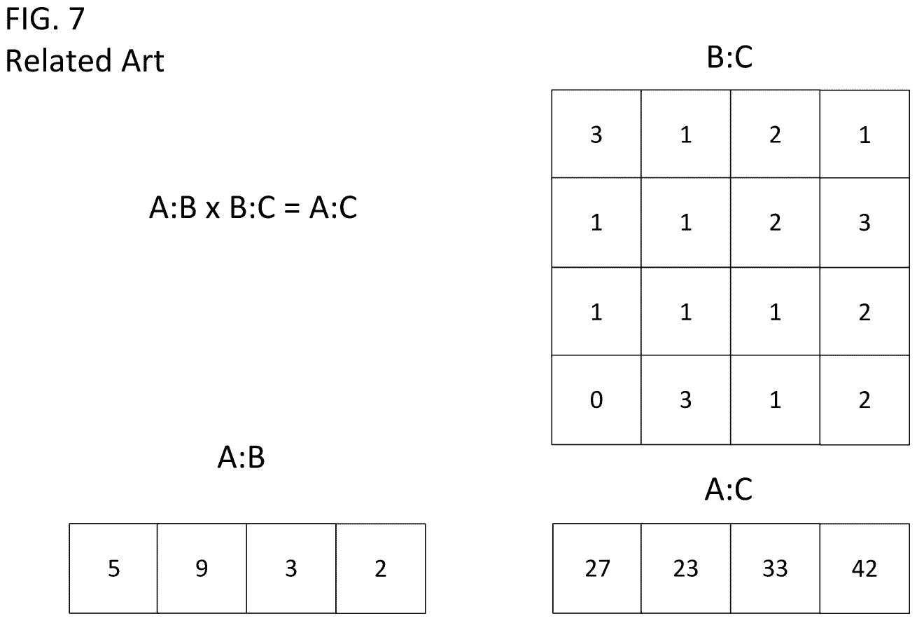

FIG. 7-9 can be used to illustrate the operation of specific embodiments of the invention in conducting matrix multiplications. FIG. 7 illustrates a standard matrix multiplication in which a matrix of size A:B is multiplied by a matrix B:C to produce a matrix A:C.

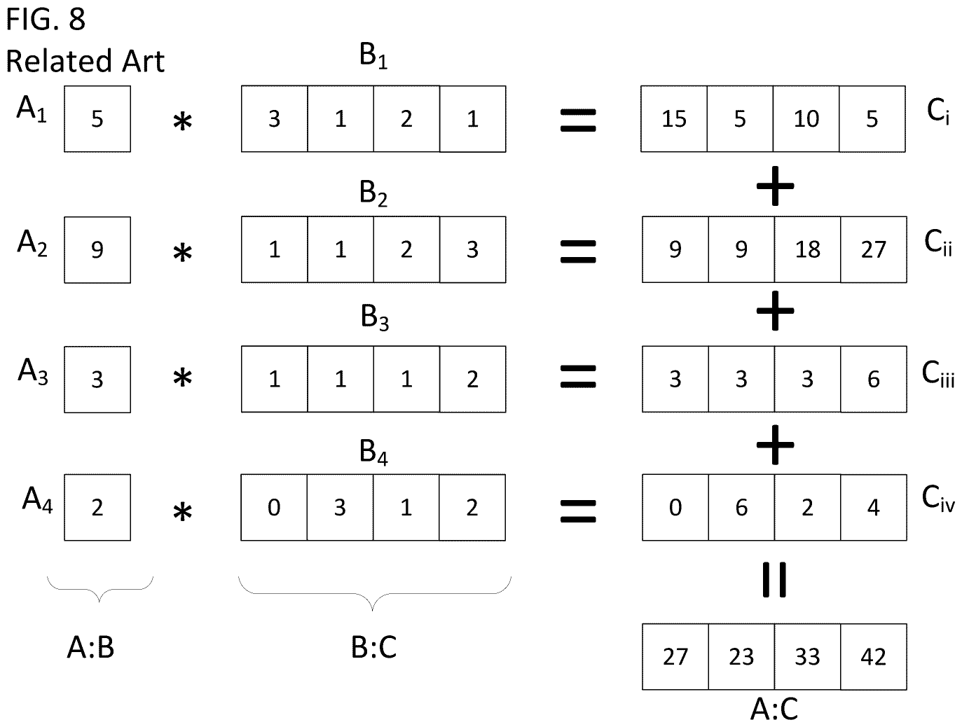

FIG. 8 illustrates the same matrix multiplication as FIG. 7 (multiplying two matrices of dimensions A:B and B:C to produce matrix A:C), broken into vector multiplications using each of the scalars from the columns of the first matrix against the vector rows of the second matrix followed by the accumulation of the product of those vector multiplications.

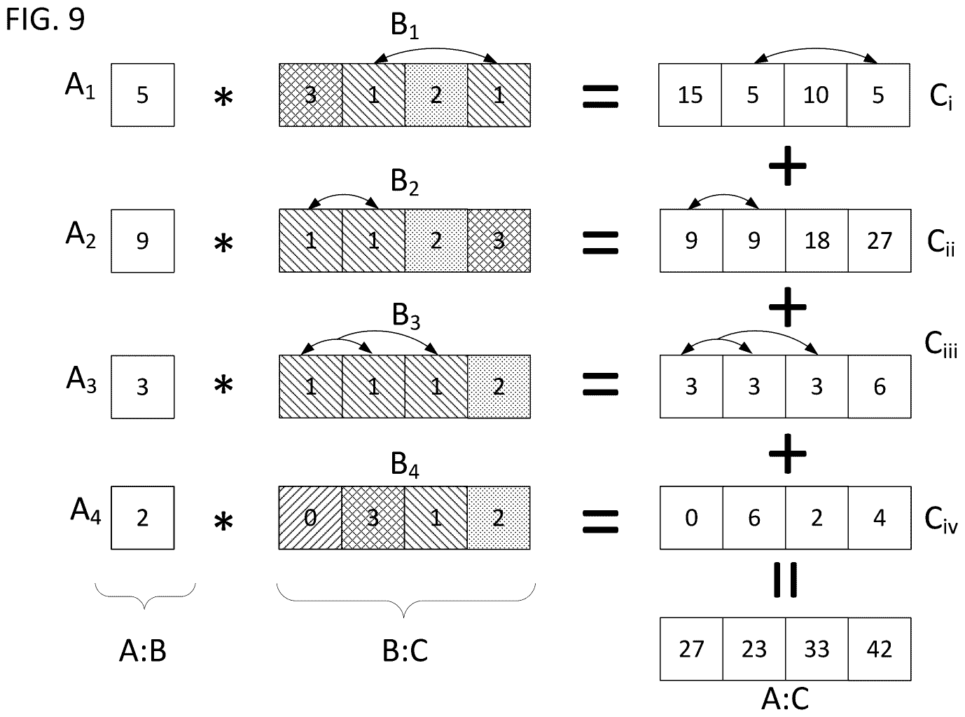

FIG. 9 illustrates the same matrix multiplication as FIG. 7 and FIG. 8 (multiplying two matrices of dimensions A:B and B:C to produce matrix A:C). FIG. 9 uses the vector multiplications and scalars from FIG. 8. However, FIG. 9 implements a connectivity mesh to improve the efficiency of the matrix multiplication. The connectivity mesh links together the same values (as illustrated with the same fill) within each matrix 1:B. For example, the second cell and fourth cell of B₁ are both “1”. The system does not need to multiply A₁ (5) by 1 two separate times, but can use the calculated value (of 5, as 5×1=5) for the multiplication of both the second and fourth cell of B₁ by A₁, such that the second and fourth cell of Cᵢ is 5. That is, A₁ times 1 is only calculated once but used twice. The connectivity mesh also connects the same values in the B₂, B₃, and B₄ matrices. The first and second cells of B₂ (“1”) are connected. The first, second, and third cells of B₃ (“1”) are connected. In the example of B₄, no values repeat and so no cells are connected. Although in the example of FIG. 9, only 1's are repeated in the 1:B matrices, any value (0, 2, 3) may be repeated.

In specific embodiments, the system of FIG. 9 can be used to multiply any two matrices of dimensions A:B and B:C by dividing the first matrix into A matrices of size 1:B and configuring a connectivity mesh so that the set of readable cells are each connected to multipliers that are associated with the values in the B:C matrix. Subsequently, the values in each of the A matrices of size 1:B can be delivered to the set of multipliers in series as inputs and the values from the set of readable cells can be read such that each of the B rows of the B:C matrix are read independently. The values that result from those B operations can be accumulated as they are read to obtain a 1:C vector (e.g., Cᵢ, Cᵢᵢ, Cᵢᵢᵢ, and Cᵢᵥ) which can then be saved off in registers while the accumulator is used for the next operation. The process in the prior sentences may be repeated for each portion of the A matrix (A₁, A₂, A₃, and A₄) and the corresponding portion of the B matrix (B₁, B₂, B₃, and B₄ respectively). Each resulting 1:C vector (Cᵢ, Cᵢᵢ, Cᵢᵢᵢ, and Cᵢᵥ) may be added together to result in a matrix of size A:C which is equal to the matrix multiplication of A:B times B:C.

The B:C matrix of FIG. 9 can include the model data of a machine intelligence model such that the values don't change, and the system is configured to compute inferences using that specific model. Given that, in specific embodiments, the connectivity mesh is configured using back end of line masks such as masks for top level metal the resulting system provides an accelerator for machine intelligence models generally that can be customized for a specific machine intelligence model at relatively low expense. This is because the cost of masks for fabricating different higher level metal layers can be a factor of 10-100 less than the cost of masks for the underlying circuitry.

In specific machine intelligence applications, the B:C matrix of FIG. 9 has an extremely large C value and a B value that is set by the input to the layer, which is usually kept relatively low. As a result, systems in accordance with this disclosure that use the multiplication processes described in the FIG. 9 can beneficially be applied to machine intelligence applications because the B value sets the number of read operations that must be conducted which impact the time it takes to conduct the computation while the C value sets the size of the set of readable cells. Given that the set of readable cells can consist essentially of a single basic access transistor, this value can be made very high for low cost. As such, the resulting system can conduct machine intelligence matrix computations at high speed and low cost.

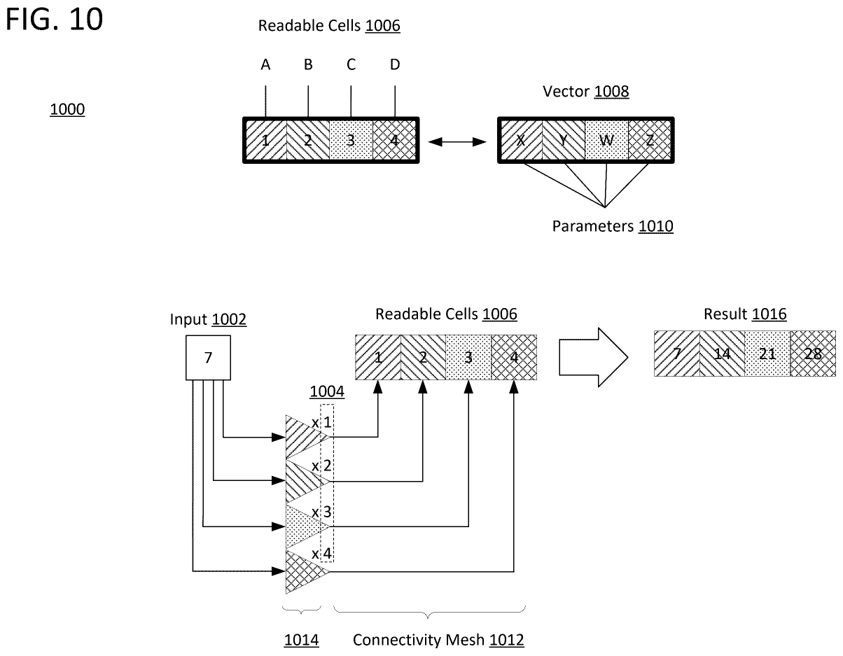

FIG. 10 illustrates system 1000 used to accelerate computations involving matrices. System 1000 incorporates multipliers 1014 having a single input. System 1000 performs multiplication of readable cells 1006 by input 1002 using possible parameter values 1004 and connectivity mesh 1012. System 1000 multiplies possible parameter values 1004 by input 1002 and maps corresponding results to readable cells 1006 (via connectivity mesh 1012) to produce result 1016. In specific embodiments, a set of readable cells (such as readable cells 1006) can be organized in rows and columns with each cell being uniquely associated with a parameter of a matrix (such as parameters 1010 of vector 1008). In these embodiments, a controller circuit can provide multiple input values (such as input 1002) to a set of multipliers (such as multipliers 1014), read the resulting output values using the read circuits and accumulate the output values in specific patterns to produce the result of a matrix multiplication (such as result 1016). The controller circuit can be configured to read certain subsets of the readable cells in a particular order to obtain the result of a matrix multiplication. In specific embodiments, input 1002 may be a scalar value. In specific embodiments, input 1002 may be a vector and a controller can be configured to provide the independent scalar values of the vector to the multipliers in sequence.

In the example of FIG. 10, each readable cell in set of readable cells 1006 is uniquely associated with a parameter 1010 of vector 1008. Vector 1008 consists of the parameters {X, Y, W, Z}. In this example, the set of readable cells 1006 of system 1000 (configured to accelerate a multiplication using vector 1008) has a cardinality of four and the four different readable cells A, B, C, and D are associated with the parameters X, Y, W, and Z respectively (as illustrated with matching fills in cells for A and X, for B and Y, for C and W, and for D and Z). This is a facile example meant to illustrate the principle of embodiments of the invention. A system similar to system 1000 may include any number of inputs, possible parameters values, readable cells, multipliers, and values in the vector. In specific implementations, the number of readable cells 1006 will be equivalent to the number of parameters in a neural network matrix (e.g., the number of readable cells in an integrated circuit implementation can be on the giga-scale where the readable cells are uniquely associated with billions of parameters). Readable cells 1006 and parameters 1010 are associated in a one-to-one correspondence and the set of readable cells 1006 is ordered to match the order of parameters 1010 in vector 1008. Notably, readable cells 1006 are not associated directly with the values for parameters 1010 but are instead associated with parameters 1010 themselves. In other words, readable cells 1006 are each associated with an entry of vector 1008 and are ordered to match the order of those entries.

In system 1000, each readable cell 1006 is coupled, via connectivity mesh 1012, to a multiplier 1014, from a set of multipliers, that outputs the product of the value of the parameter and the input. Multipliers 1014 may be dedicated circuits that always output a number multiplied by the value of the parameter. In other words, a multiplier may be programmed or built to always multiply a single input (such as input 1002) by a specific number (such as 0, 1, 2, etc.). Different multipliers may multiply the input by a different specific number than other multipliers in the system. For example, one multiplier may always multiply the input by 1, another multiplier may always multiply the input by 2, etc. Instead of a multiplier that multiplies the input by 0, the input may be connected to ground or some other constant representation of 0. The set of multipliers can each receive input 1002 (e.g., a scalar) and be configured to multiply input 1002 by a fixed value (0, 1, 2, etc.) to output the product of the scalar times that fixed value. The fixed values can be all of the potential values of the parameters of vector 1008. In specific embodiments, input 1002 can be a vector and a controller can be configured to provide the independent scalar values of the vector to the multipliers 1014 in sequence.

Vector 1008 consists of the parameters {X, Y, W, Z}, where those parameters have the values {1, 2, 3, 4} respectively. In this example, there are four multipliers 1014 that are hardwired or hardcoded to multiply by the values 1, 2, 3, and 4 respectively. The same four multipliers 1014 are input-coupled to input 1002 that will be used to multiply the vector. In this example, readable cell A is associated with parameter X and is coupled via connectivity mesh 1012 to the multiplier 1014 that is built to multiply by 1. Continuing with this example, readable cell B is associated with parameter Y and is coupled via the connectivity mesh to the multiplier 1014 that is built to multiply by 2. The same pattern continues for readable cells C and D. The four multipliers 1014 in this example form a set of multipliers 1014. In specific embodiments, the set of multipliers 1014 will include a multiplier 1014 for every possible (e.g., potential) parameter value 1004. For example, if the parameters X, Y, W, and Z could have any single-digit value, the set of multipliers would include 10 multipliers where each multiplier was built to multiply an input (e.g., input 1002) by one of the values from zero to nine. In actual implementations, the multiplier that was built to multiply by zero would be connected to ground or some other constant representation of zero since the multiplication computation is independent of the input in that case and is always zero.

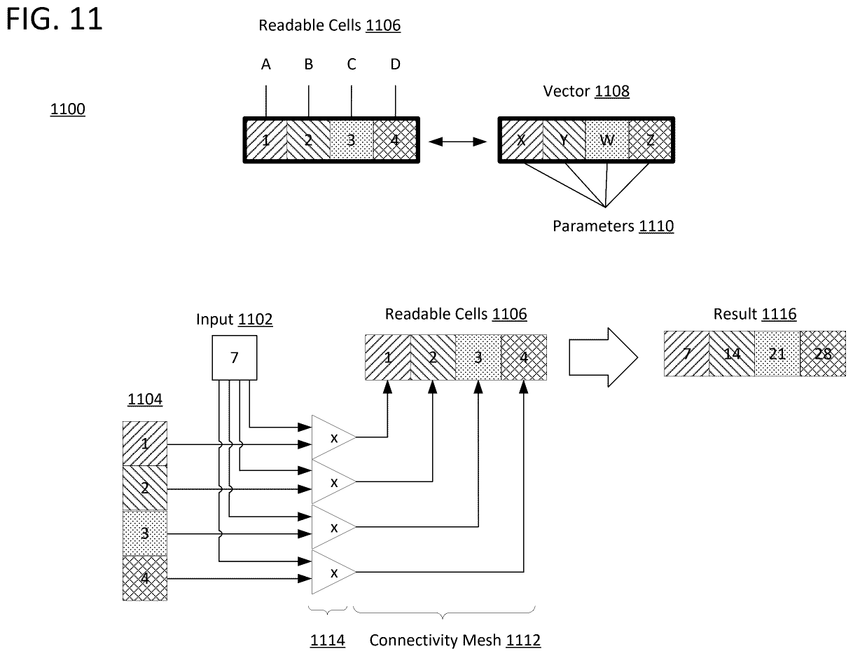

FIG. 11 illustrates system 1100 used to accelerate computation involving matrices. System 1100 incorporates multipliers 1114 having two inputs. System 1100 performs multiplication of readable cells 1106 by input 1102 using possible parameter values 1004 and connectivity mesh 1112. System 1100 multiplies possible parameter values 1104 by input 1102 and maps corresponding results to readable cells 1106 (via connectivity mesh 1112) to produce result 1116. System 1100 may be similar to system 1000, except that each multiplier 1014 has a single input (e.g., input 1002) in system 1000 and multipliers 1114 have two inputs (e.g., input 1102 and an input possible parameter value 1104) in system 1100. In specific embodiments, input 1102 may be a scalar value. In specific embodiments, input 1102 may be a vector and a controller can be configured to provide the independent scalar values of the vector to the multipliers in sequence.

Each readable cell 1106 is uniquely associated with a parameter 1110 of vector 1108. Vector 1108 consists of the parameters {X, Y, W, Z}. In this example, the set of readable cells 1106 of system 1100 (configured to accelerate a multiplication using vector 1108) has a cardinality of four and the four different readable cells A, B, C, and D are associated with the parameters X, Y, W, and Z respectively (as illustrated with matching fills in cells for A and X, for B and Y, for C and W, and for D and Z). This is a facile example meant to illustrate the principle of embodiments of the invention. A system similar to system 1100 may include any number of inputs, possible parameters values, readable cells, multipliers, and values in the vector. In specific implementations, the number of readable cells 1106 will be equivalent to the number of parameters in a neural network matrix (e.g., the number of readable cells in an integrated circuit implementation can be on the giga-scale where the readable cells are uniquely associated with billions of parameters). Readable cells 1106 and parameters 1110 are associated in a one-to-one correspondence and the set of readable cells 1106 is ordered to match the order of parameters 1110 in vector 1108. Notably, readable cells 1106 may not be associated directly with the values for parameters 1110 but may instead be associated with parameters 1110 themselves. In other words, readable cells 1106 may each be associated with an entry of vector 1108 and may be ordered to match the order of those entries.

In system 1100, each readable cell 1106 is coupled, via connectivity mesh 1112, to a multiplier 1114, from a set of multipliers 1114, that outputs the product of the possible parameter value 1104 and input 1102. Different multipliers may multiply input 1102 by a different specific number than other multipliers in the system. In other words, possible parameter values 1104 may each be unique values.

In specific embodiments, each readable cell 1106 is coupled, via connectivity mesh 1112, to a multiplier 1114 that is input-coupled to a value of a parameter associated with the readable cell. In other words, multiplier 1114 may have two inputs-input 1102 and an input from possible parameter values 1104. In specific embodiments, possible parameter values 1104 may change or be configurable. In specific embodiments, scaling may be implemented by the values provided to multipliers 1114. The set of multipliers 1114 can each receive the scalar as input 1102 and different values of the parameters of the vector as operand inputs (e.g., possible parameter values 1104). The multipliers 1114 are input-coupled to a value (e.g., input 1102) and the different values (e.g., possible parameter values 1104) in that those values are delivered to the multiplier 1114 in order for the multiplier 1114 to execute a multiplication using those values as operands.

Vector 1108 consists of the parameters {X, Y, W, Z}, where those parameters have the values {1, 2, 3, 4} respectively. In this example, there are four multipliers 1114 that are input-coupled to the values 1, 2, 3, and 4 respectively. The same four multipliers 1114 are also input-coupled to input 1102 that will be used to multiply vector 1108. In this example, readable cell A is associated with parameter X and is coupled via connectivity mesh 1112 to the multiplier 1114 that is input-coupled to 1. Continuing with this example, readable cell B is associated with parameter Y and is coupled via connectivity mesh 1112 to the multiplier 1114 that is input-coupled to 2. The same pattern continues for readable cells C and D. The four multipliers 1114 in this example form a set of multipliers 1114. In specific embodiments, the set of multipliers 1114 will include a multiplier 1014 for every possible (e.g., potential) parameter value 1104. For example, if the parameters X, Y, W, and Z could have any single-digit value, the set of multipliers would include 10 multipliers where each multiplier was input-coupled to one of the values from zero to nine. In actual implementations, the multiplier that was input-coupled to zero may be connected to ground or some other constant representation of zero since the multiplication computation is independent of the input in that case and is always zero.

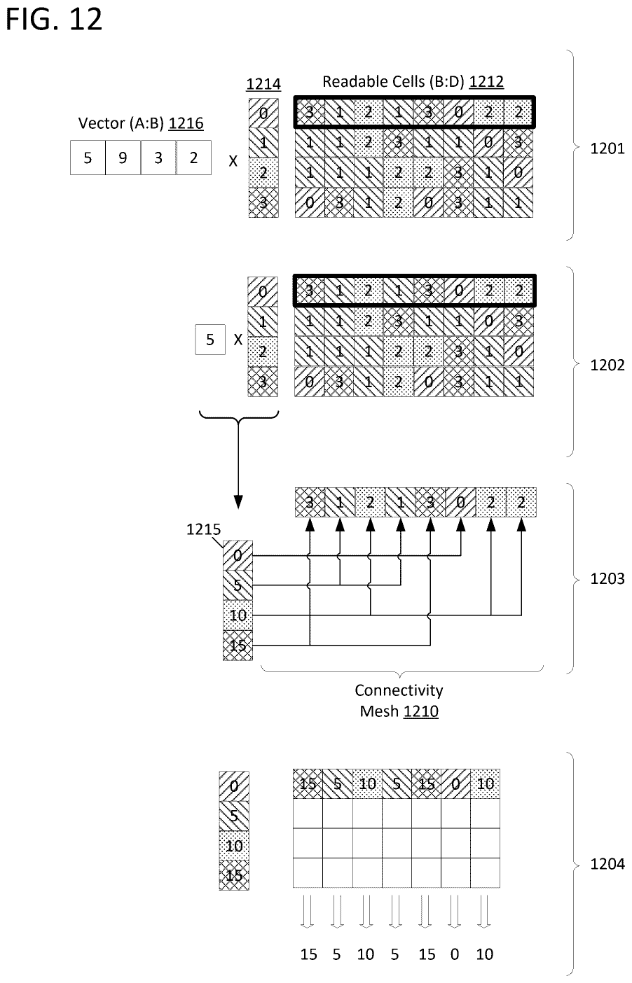

FIG. 12 illustrates how specific embodiments of the systems disclosed herein may multiply vector 1216 by readable cells 1212. The first row, row 1201, illustrates a set of readable cells 1212 and side table 1214 of values where the values include every potential value of the parameters associated with readable cells 1212 (e.g., 0, 1, 2, and 3). Readable cells 1212 have the same fill patterns as elements of side table 1214 to show that they can be connected via connectivity mesh 1210 (e.g., elements of side table 1214 having a given value can be connected to readable cells 1212 associated with that value).

The second row, row 1202, illustrates how a value (5, in the illustrated example) of vector 1216 can be multiplied by the values in side table 1214 to obtain scaled table 1215. The value of vector 1216 can be provided as an input to a multiplier. In specific embodiments, the multiplier may be built to multiply the value of vector 1216 by a specific value of side table 1214 (e.g., the specific value is not input to the multiplier). In specific embodiments, the multiplier may input both the value of vector 1216 and the specific value from side table 1214 (e.g., the value 0, 1, 2, or 3) where the values of side table 1214 may be programmable or changing.

The third row, row 1203, illustrates how connectivity mesh 1210 may connect values of scaled table 1215 to the corresponding values in the first row of readable cells 1212. In FIG. 12, the first value “0” of side table 1214 corresponds to the 6^{th} cell in the first row of readable cells 1212. Accordingly, the first value “0” of scaled table 1215 (corresponding to the first value “0” of side table 1214) maps to the 6^{th} cell in the first row of readable cells 1212. As another example, the third value “2” of side table 1214 corresponds to the 3^{rd}, 7^{th}, and 8^{th} cells in the first row of readable cells 1212. Accordingly, the third value “10” of scaled table 1215 (corresponding to the third value “2” of side table 1214) maps to the 3^{rd}, 7^{th}, and 8^{th} cells in the first row of readable cells 1212. The pattern continues for the other values of side table 1214, scaled table 1215, and readable cells 1212.

Connectivity mesh 1210 can take on various characteristics in different applications. The connectivity mesh can connect the outputs of a set of multipliers to the set of readable cells 1212. Connectivity mesh 1210 can comprise a mesh of wires and vias in the metal or wiring layers of one or more integrated circuits. Connectivity mesh 1210 can comprise conductive connections for optical or electronic signals. Connectivity mesh 1210 can connect the output of a multiplier, that is associated with a given parameter value by having that parameter value as an input or hardcoded, to a set of readable cells 1212 that are all associated with parameters having that given parameter value. For example, the multiplier could have a fixed input value of 3 and connectivity mesh 1210 could connect the output of the multiplier to every readable cell 1212 associated with a parameter having a value 3. Connectivity mesh 1210 can have various fan outs from the multipliers based on the number of parameters in a vector that have the various values associated with those multipliers.

The final row, row 1204, illustrates how a word line (e.g., row) of the set of readable cells 1212 can be read while the corresponding value of vector 1216 is provided from scaled table 1215. In specific embodiments, readable cells 1212 overwrite the values of scaled table 1215 into the readable cells. In these embodiments, the original values of readable cells 1212 (from row 1201) may no longer be stored in readable cells 1212. In other specific embodiments, readable cells 1212 may retain their original values (from row 1202) and may not be rewritten to store values from scaled table 1215.

Using four (B) iterations of the processes of rows 1201 through 1204, the full vector multiplication (e.g., of vector 1216 with values {5, 9, 3, 2}) can be computed by accumulating the values that are read out during each iteration. In this example, the number of multiplications required for a row of readable cells 1212 is 4 and the total number of multiplications required to complete the whole vector multiplication is 16. Using a more typical matrix multiplication process, the number of multiplications required for a row of readable cells would be 8 and the total number of multiplications required to complete the whole vector would be 32. As shown in this example, performing vector multiplication as described herein reduces the number of discrete multiplications required. Additionally, the dimension D is likely to stretch into the millions, billions, and beyond, while the number of potential values of the parameters in dimension D will stay stable (e.g., side table 1214 will remain small relative to dimension D). As a result, the number of multiplications will be fixed at the number of potential values of the parameters times the size of dimension B (e.g., 16), while the number of multiplications that would otherwise be required would be equal to dimension B times dimension D (e.g., 4 billion).

The cardinality of the set of multipliers can be set to different values in different applications. In specific embodiments, the set of multipliers can be associated with every value in a vector in a one-to-one correspondence. For example, in a vector with 1,000 parameters and 57 unique values, the set of multipliers could be a set of 57 multipliers with each multiplier associated uniquely with one of the 57 unique values. In specific embodiments, the set of multipliers can be associated with every potential value of a parameter in the vector. For example, in a vector with 1 trillion parameters where each parameter could be one of 50,000 unique values, the set of multipliers could be a set of 50,000 multipliers with each multiplier associated uniquely with one of the 50,000 unique values. In specific embodiments, the set of multipliers will include a multiplier for every potential value of the parameters as set by the resolution of the data type used to represent the parameters. For example, if the parameters were represented by a 4-bit data type there would be a set of 16 multipliers, and if the parameters were represented by a 16-bit data type there would be a set of 65,536 multipliers. In specific embodiments, the parameters in a vector are n-bit values and the set of multipliers has a cardinality of two to the n power.

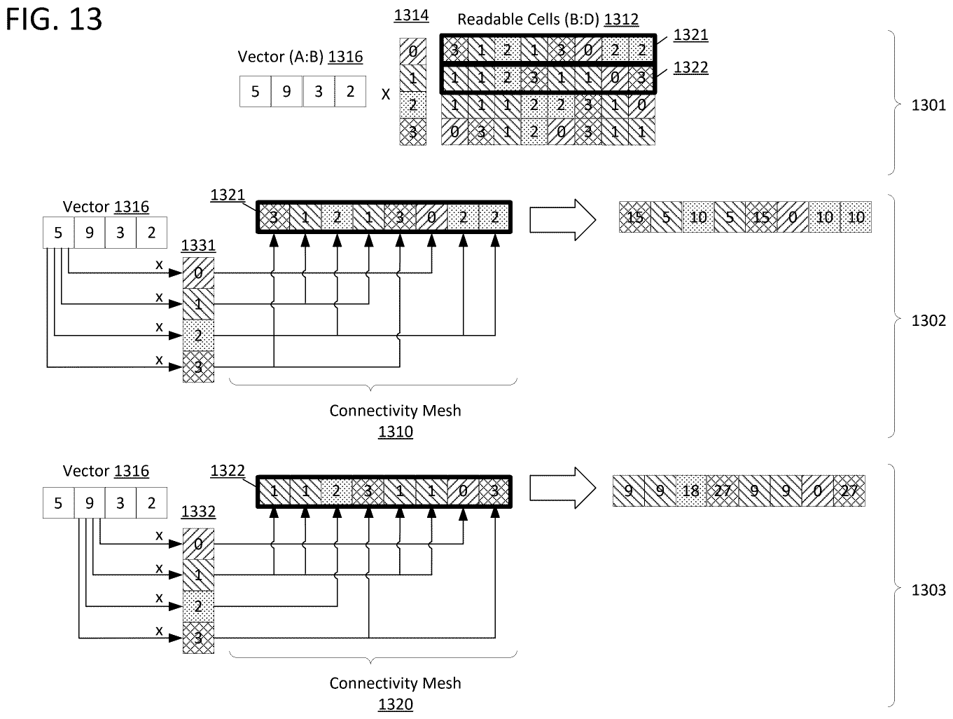

FIG. 13 illustrates an example of multiple portions of a connectivity mesh that may be used when multiplying corresponding portions of vector 1316 by two rows of readable cells 1312. The first row, row 1301, illustrates a set of readable cells 1312 and side table 1314 of values where the values include every potential value of the parameters associated with readable cells 1312 (e.g., 0, 1, 2, and 3). Readable cells 1312 have the same fill patterns as elements of side table 1314 to show that they can be connected via connectivity mesh 1310 (e.g., elements of side table 1314 having a given value can be connected to readable cells 1312 associated with that value). Readable cells 1312 may be similar to readable cells 1212, vector 1316 may be similar to vector 1216, and side table 1314 may be similar to side table 1214.

A value of vector 1316 may be multiplied by side table 1314, which is mapped to corresponding values in readable cells 1312. The second row, row 1302, illustrates how connectivity mesh 1310 may connect values of scaled side table 1331 to the corresponding values in readable cells 1312. In this example, the first value (5) of vector 1316 is multiplied by first row 1321 of readable cells 1312. Connectivity mesh 1310 may be similar to connectivity mesh 1210. The first value (0) of side table 1314, corresponds to the 6^{th} cell in first row 1321 of readable cells 1312. Accordingly, the value (0) of scaled side table 1331 corresponding to the first value (0) of side table 1314 and the input (5) from vector 1316 maps to the 6^{th} cell in first row 1321 of readable cells 1312. The second value of the side table (1) corresponds to the 2^{nd} and 4^{th} cells in first row 1321 of readable cells 1312. Accordingly, the value (5) of scaled side table 1331 corresponding to the second value (1) of side table 1314 maps to the 2^{nd} and 4^{th} cells in first row 1321 of readable cells 1312. The pattern continues for the third and fourth values of side table 1314 and first row 1321.

The third row, row 1303, illustrates how connectivity mesh 1320 may connect values of scaled side table 1332 to the corresponding values in readable cells 1312. In this example, the second value (9) of vector 1316 is multiplied by second row 1322 of readable cells 1312. The first value (0) of side table 1314 corresponds to the 7^{th} cell in second row 1322 of readable cells 1312. Accordingly, the value (0) of scaled side table 1332 corresponding to the first value (0) of side table 1314 and the input (9) from vector 1316 maps to the 7^{th} cell in second row 1322 of readable cells 1312. The second value (1) of side table 1314 corresponds to the 1^{st}, 2^{nd}, 5^{th}, and 6^{th} cells in second row 1322 of readable cells 1312. Accordingly, the value (9) of scaled side table 1332 corresponding to the second value (1) of side table 1214 maps to the 1^{st}, 2^{nd}, 5^{th}, and 6^{th} cells in second row 1322 of readable cells 1312. The pattern continues for the third and fourth values of side table 1314 and second row 1322. The pattern also continues for the values of side table 1314 and other rows of readable cells 1312.

Using four iterations multiplying rows of readable cells 1312, the full vector multiplication (e.g., of vector 1316 with values {5, 9, 3, 2} and readable cells 1312) can be computed by accumulating the values that are read out during each iteration. In this example, the number of multiplications required for a row of readable cells 1312 is 4 and the total number of multiplications required to complete the whole vector multiplication is 16. Using a more typical matrix multiplication process, the number of multiplications required for a row of readable cells would be 8 and the total number of multiplications required to complete the whole vector would be 32. As shown in this example, performing vector multiplication as described herein reduces the number of discrete multiplications required. Additionally, the dimension D is likely to stretch into the millions, billions, and beyond, while the number of potential values of the parameters in dimension D will stay stable (e.g., side table 1314 will remain small relative to dimension D). As a result, the number of multiplications will be fixed at the number of potential values of the parameters times the size of dimension B (e.g., 16), while the number of multiplications that would otherwise be required would be equal to dimension B times dimension D (e.g., 4 billion).

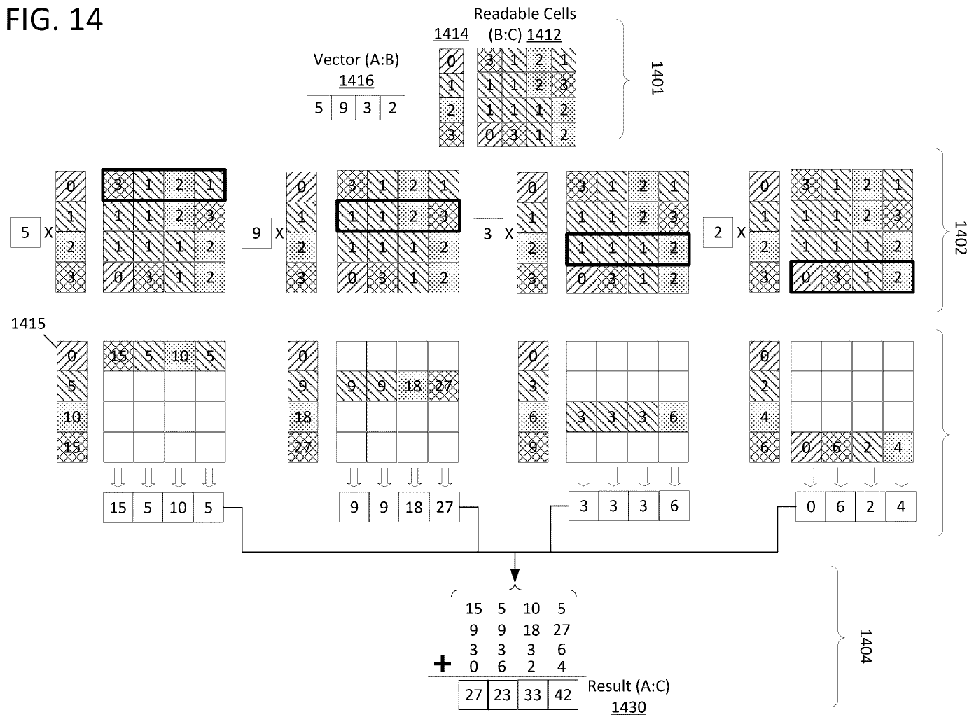

FIG. 14 illustrates how specific embodiments of the systems disclosed herein may multiply vector 1416 by multiple rows of readable cells 1412 and accumulate the results to produce result 1430. FIG. 14 illustrates how specific embodiments of the systems disclosed herein can conduct the operation illustrated by FIG. 7-9 with minimal multiplications (e.g., an operation with matrices of the same dimensions as in FIG. 7-9). Each column across row 1402 and row 1403 illustrates multiplication associated with a row of readable cells. The first row, row 1401, illustrates a set of readable cells 1412 that are associated with values of the matrix B:C and side table 1414 of values where the values include every potential value of the parameters in B:C (e.g., corresponding to readable cells 1412). Readable cells 1412 have the same fill patterns as elements of side table 1414 to show that they can be connected via a connectivity mesh (e.g., elements of side table 1414 having a given value can be connected to readable cells 1412 associated with that value).

The second row, row 1402, illustrates how a value of vector 1416 can be multiplied by the values in side table 1414 (e.g., to obtain scaled side table 1415). The value of vector 1416 can be provided as an input to a multiplier. In specific embodiments, the multiplier may be built to multiply the value of vector 1416 by a specific number (e.g., the specific number is not input to the multiplier). In specific embodiments, the multiplier may input both the value of vector 1416 and a value from side table 1414 (e.g., the value 0, 1, 2, or 3) where the values of side table 1414 may be programmable or changing.

The third row, row 1403, illustrates how a word line (e.g., row) of the set of readable cells 1412 can be read while the corresponding value of vector 1416 is provided to the side table 1414 to obtain scaled side table 1415 of the row multiplied by the values of a vector of the matrix. Using four iterations (the four columns of row 1402 and row 1403) of such a process, the full vector multiplication can be computed by accumulating the values that are read out during each iteration.

The fourth row, row 1404, illustrates the accumulating, or adding, steps of matrix multiplication. The calculated values corresponding to a column of readable cells 1412 are added together to create result 1430. Result 1430 has dimensions A:C. In specific embodiments of the invention, the disclosed systems can include an accumulator. The accumulator can be coupled to a read circuit. As the read circuit reads the product of a value from vector 1416 and a value associated with the readable cells 1412 (a possible parameter value from side table 1414), the accumulator can accumulate the product with a stored value. In this way, matrix multiplication can be facilitated by conducting the multiply-accumulate operations as the readable cells 1412 are read in sequence and the resulting product values are accumulated in the accumulator. In specific embodiments of the invention, the disclosed systems can include multiple read circuits and accumulators so that a specific input can be multiplied by separate vectors simultaneously.

In specific embodiments, the multipliers can be bit serial multipliers, and the read circuits can be coupled to adders or accumulators that are also configured for bit serial operation. The multipliers can provide signals to the connectivity mesh in a bit-serial manner and transmit signals through the connectivity mesh as they are calculated. The accumulators and adders can receive the signals from the connectivity mesh via readable cells 1412 and add or accumulate the values as they are received. For example, a parallel adder could operate bit-serially on all of the values being read from readable cells 1412 to calculate an output vector (e.g., result 1430) as the bits are received from readable cells 1412.

In specific embodiments of the invention, the disclosed system can include a parallel adder. The parallel adder can be a large adder that can take in the output vectors from several subsets of readable cells and add the values together in parallel. For example, the parallel adder could take in five large vectors of length X that are read from five subsets of readable cells and add the corresponding parameters of each of the five vectors in a single clock cycle to produce an output vector (e.g., result 1430) of length X equal to the sum of all those vectors. In this manner, the system could be configured to do the multiply and accumulate steps for a matrix multiplication in a single clock cycle. In specific embodiments, the parameters of a given vector could be associated with more than one readable cell with the different readable cells each associated with more than one set of multipliers so that multiple input values could be multiplied by the parameter and accumulated in parallel in a single clock cycle. In specific embodiments, the readable cells associated with more than one vector could be read and added in parallel so that a single input value could be multiplied by different vectors and accumulated in parallel in a single clock cycle.

In the example of FIG. 14, the total number of multiplications required is 16 which is the same as would be required in FIG. 8. However, this example is facile in that the dimension C is likely to stretch into the millions, billions, and beyond, while the number of potential values of the parameters in dimension C will stay stable (e.g., side table 1414 will remain small relative to dimension C). As a result, the number of multiplications will be fixed at the number of potential values of the parameters times the size of dimension B (e.g., 16) while the number of multiplications that would otherwise be required would be equal to dimension B times dimension C (e.g., 4 billion).

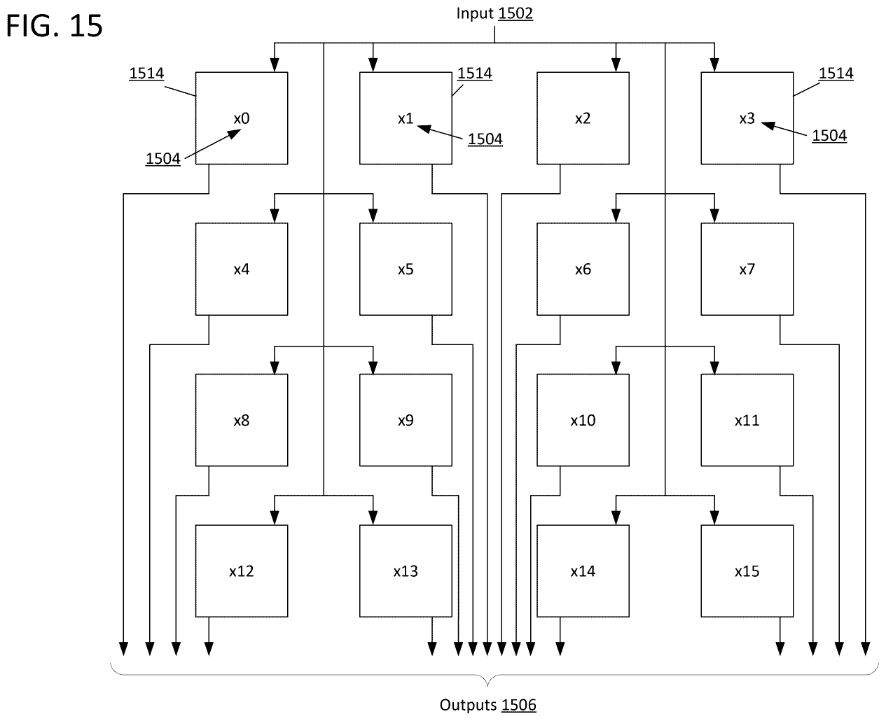

FIG. 15 illustrates multipliers 1514 designed to multiply input 1502 by fixed values 1504. In specific embodiments, multipliers 1514 may take on different physical shapes because they are designed to multiply input 1502 by different fixed values 1504. However, the different multipliers 1514 can be designed to have an identical footprint on a layout so that they can be compactly arranged in an array. In specific embodiments, the set of multipliers 1514 can be placed towards the center of a large set of readable cells so that the connectivity mesh can spread out from the center of the block in multiple directions to minimize overlap of routing. Fixed values 1504 may be associated with every possible parameter of a matrix used in matrix multiplication. Input 1502 may be associated with a value (e.g., a scalar value) of a vector used in matrix multiplication.

Each multiplier 1514 may produce an output 1506 corresponding to the product of input 1502 and the fixed value 1504 corresponding to that multiplier 1514. Each output 1506 of multipliers 1514 may be coupled (via a connectivity mesh) to a readable cell. In specific embodiments, multipliers 1514 may form part of the connectivity mesh. In other specific embodiments, multipliers 1514 may be separate from, but still output to, the connectivity mesh. Multipliers 1514 may be dedicated circuits that always output input 1502 multiplied by the corresponding fixed value 1504. In other words, multipliers 1514 may be programmed or built to always multiply a single input (such as input 1502) by a specific number (such as 0, 1, 2, etc.). Different multipliers 1514 may multiply input 1502 by a different fixed value 1504 than other multipliers 1514 in the system. For example, one multiplier 1514 may always multiply input 1502 by 1, another multiplier 1514 may always multiply input 1502 by 2, etc. Instead of a multiplier that multiplies input 1502 by 0, input 1502 may be connected to ground or some other constant representation of 0. Input 1502 may be a scalar value. Fixed values 1504 may correspond to all of the potential values of the parameters of a matrix used in matrix multiplication.

In specific embodiments, the set of multipliers 1514 includes a multiplier 1514 for every possible parameter value of the matrix in the matrix multiplication. In the example of FIG. 15, the parameters of the matrix could have any value from 0 to 15. The set of multipliers 1514 includes 16 multipliers where each multiplier is built to multiply input 1502 by one of the values from 0 to 15. In actual implementations, the multiplier 1514 that is built to multiply by zero may be connected to ground or some other constant representation of zero since the multiplication computation is independent of input 1502 in that case and is always zero.

The set of fixed inputs can be hard coded into the circuitry of the system in various ways. For example, in FIG. 15, the fixed values 1504 can be integrated into the logic of each multiplier 1514 so that each multiplier 1514 is configured to only receive a single true input value (input 1502). Each multiplier 1514 may have a slightly different connectivity or logic structure so that it is optimized for multiplication via its corresponding fixed value 1504.

In specific embodiments, fixed values 1504 are not built into multipliers 1514. Instead, values corresponding to parameters of the matrix used in matrix multiplication may be input to the multipliers. In these embodiments, the multipliers have two inputs: the input value corresponding to the parameters of the matrix (corresponding to fixed value 1504), and the input value of the vector (e.g., corresponding to input 1502). As another example, the fixed inputs can be stored in hard coded registers and be provided to the multiplier as a standard input is provided to a multiplier circuit with the exception that the same value and only that same value can be provided to one input of the multiplier circuit.

The multiplier inputs can be provided in various ways in different applications. The multiplier inputs can be a set of fixed inputs (e.g., fixed values 1504) and an input value (e.g., input 1502). The set of fixed inputs can be the values of the parameters in the matrix that will be multiplied, and the input value can be the value that the vector will be multiplied by. The input value can be provided by a controller. The controller can be a higher-level controller that is orchestrating the multiplication of two vectors or two matrices where the scalar-vector multiplication is a single part of that multiplication.

Multipliers 1514 can take on various forms in different applications. In specific embodiments, the set of multipliers 1514 can include standard digital multiplier circuits that are selected to operate with inputs having data types of the values of the vector. For example, multipliers 1514 can be two operand input 4-bit floating point multipliers. Multipliers 1514 can be clocked or static logic circuits. In specific embodiments, the set of multipliers 1514 can be a mixed signal or analog circuit block that outputs an analog current or voltage signal that is representative of the multiplication output 1506. The voltage or current between zero and supply could be divided into a large number of values to represent multibit values. The set of multipliers 1514 can accordingly output (e.g., as output 1506) a set of analog reference voltage or currents to the set of readable cells through the connectivity mesh.

Multipliers 1514 can include ancillary circuitry in addition to the circuitry that conducts the multiplication of the operands in different applications. In specific embodiments, the set of multipliers 1514 can include a set of serializers to serialize the output values (e.g., output 1506) for transmission through the connectivity mesh to the readable cells. The serializer can serialize a digital value into a set of pulses or an analog signal into a set of pulses with varying amplitudes such that each pulse is a multibit analog signal. In these embodiments, the read circuits that are configured to read the readable cells can include a set of deserializers to resolve the values after reading them from the readable cells. In specific embodiments, the set of multipliers 1514 can include a set of amplifiers to amplify the output values (e.g., output 1506) for transmission through the connectivity mesh. The amplifiers, serializers, or amplifiers and serializers can be trimmed to provide the appropriate degree of amplification based on the number of readable cells connected to a given multiplier 1514 to optimize power consumption. For example, a multiplier 1514 connected to a small number of readable cells can have low amplification and power consumption to minimize power consumption while a multiplier connected to many readable cells can have high amplification and higher power consumption to meet speed requirements. The trimming can be done in a calibration step in which the load on each multiplier 1514 is determined.

Multipliers 1514 can be bit serial multipliers, and the read circuits can be coupled to adders or accumulators that are also configured for bit serial operation. Multipliers 1514 can provide signals to the connectivity mesh in a bit-serial manner and transmit signals through the connectivity mesh as they are calculated. The accumulators and adders can receive the signals from the connectivity mesh via the readable cells and add or accumulate the values as they are received. For example, a parallel adder could operate bit-serially on all of the values being read from the readable cells to calculate an output vector as the bits are received from the readable cells.

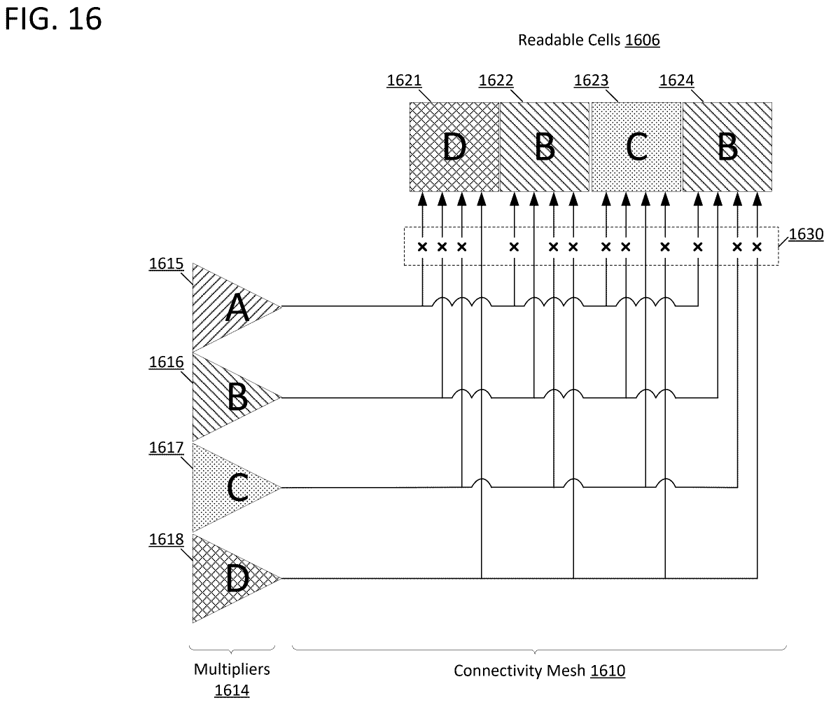

FIG. 16 illustrates connectivity mesh 1610 connecting the output of multipliers 1614 with corresponding readable cells 1606. Connectivity mesh 1610 can take on various characteristics in different applications and may be configurable. Multipliers 1614 include multiplier 1615, multiplier 1616, multiplier 1617, and multiplier 1618. Readable cells 1606 includes cell 1621, cell 1622, cell 1623, and cell 1624. Connectivity mesh 1610 can comprise a mesh of wires and vias in the metal or wiring layers of one or more integrated circuits. Connectivity mesh 1610 can comprise conductive connections for optical or electronic signals.

In specific embodiments, multipliers 1614 may each be associated with a given parameter value (A, B, C, or D) by having that parameter hardwired into that multiplier 1614 (e.g., not as an input). Connectivity mesh 1610 can connect the output of each multiplier 1614 to a subset of readable cells 1606 that are all associated with that given parameter value (A, B, C, or D). For example, multiplier 1618 could have a hardwired value of 5 (corresponding to D) and connectivity mesh 1610 could connect the output of multiplier 1618 to every readable cell associated with parameter D (e.g., having a value 5). Connectivity mesh 1610 can have various fan outs from multipliers 1614 based on the number of parameters in a vector that have the various values associated with those multipliers 1614.

In specific embodiments, multipliers 1614 may each be associated with a given parameter value (A, B, C, or D) by having that parameter value as an input. Connectivity mesh 1610 can connect the output of multipliers 1614 to a subset of readable cells that are all associated with that given parameter value (A, B, C, or D). For example, the multiplier 1618 could have a fixed input value of 5 (corresponding to D) and connectivity mesh 1610 could connect the output of multiplier 1618 to every readable cell associated with parameter D (e.g., having a value 5). Connectivity mesh 1610 can have various fan outs from multipliers 1614 based on the number of parameters in a vector that have the various values associated with those multipliers 1614.

In specific embodiments, connectivity mesh 1610 can be configurable. Connectivity mesh 1610 can be configurable when the system is operational. For example, connectivity mesh 1610 can have a set of configurable switches 1630 that modify which readable cells 1606 are connected to each multiplier 1614. Connectivity mesh 1610 can be configurable when the system is being fabricated. In embodiments in which the system is implemented as an integrated circuit, connectivity mesh 1610 can be configurable when a set of transistors that will ultimately form connectivity mesh 1610 are being formed by implanting certain transistors with diffusion implants to render a first subset of switches 1630 conductive and not implanting such an implant on certain other transistors so a second subset of switches 1630 is not conductive. As another example, connectivity mesh 1610 can be configurable when the wiring layers of the integrated circuit are being formed by coupling the outputs of multipliers 1614 and the readable cells 1606 using different wiring patterns. Connectivity mesh 1610 can be formed in the metal layers of an integrated circuit. As another example, connectivity mesh 1610 can be configurable during back-end processing. For example, fuses or anti-fuses can be subjected to processing or high energy applications that modify their conductivity states to form connectivity mesh 1610 with different connectivity between the outputs of multipliers 1614 and readable cells 1606. Connectivity mesh 1610 can be configurable after the system has been fabricated or when the system is operational. For example, switches 1630 could be memory cells such as static random-access memories, flash cells, or other memory cells which can be programmed to set the conductivity state of certain portions of connectivity mesh 1610 to connect specific multiplier outputs with specific readable cells (e.g., multiplier 1616 with cells 1622 and 1624, all of which correspond to parameter D). As another example, switches 1630 could be standard field effect transistors which receive control signals at their gates to set the conductivity state of certain portions of connectivity mesh 1610 to connect specific multiplier outputs with specific readable cells (e.g., multiplier 1616 with cells 1622 and 1624, all of which correspond to parameter D).

Readable cells 1606 may be associated with model data of a machine intelligence model such that the values stored in readable cells 1606 don't change and the system is configured to compute inferences using that specific model. Given that, in specific embodiments, connectivity mesh 1610 is configured using back end of line masks such as masks for top level metal. The resulting system provides an accelerator for machine intelligence models generally that can be customized for a specific machine intelligence model at relatively low expense. This is because the cost of masks for fabricating different higher level metal layers can be a factor of 10-100 less than the cost of masks for the underlying circuitry.

In specific machine intelligence applications the readable cells 1606 may have an extremely large number of columns and a number of rows that is set by the input to the layer, which is usually kept relatively low. As a result, matrix multiplication using connectivity mesh 1610 can beneficially be applied to machine intelligence applications because the number of rows of readable cells 1606 sets the number of read operations that must be conducted, which impacts the time it takes to conduct the computation, while the number of columns of readable cells 1606 sets the size of the set of readable cells 1606. Given that the set of readable cells can consist essentially of a single basic access transistor, this value can be made very high for low cost. As such, the resulting system can conduct machine intelligence matrix computations at high speed and low cost.

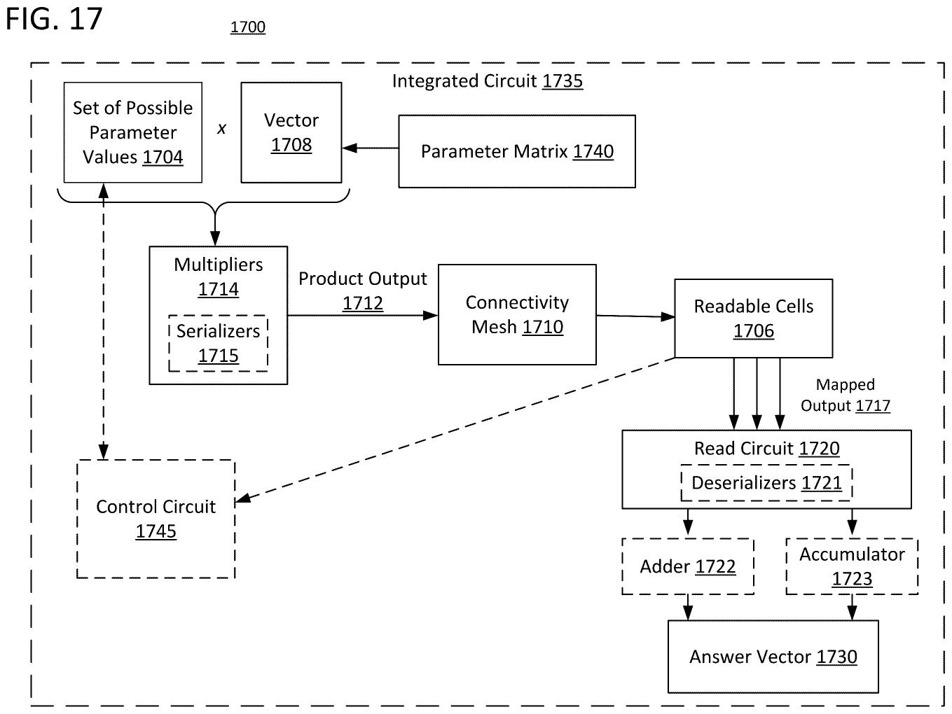

FIG. 17 illustrates an example block diagram of system 1700 performing accelerated matrix multiplication in accordance with specific embodiments of the inventions disclosed herein. In the matrix multiplication of system 1700, parameter matrix 1740 is multiplied by readable cells 1706. In specific embodiments, system 1700 may be implemented on integrated circuit 1735.

Parameter matrix 1740 is made up of various parameters having values. Parameter matrix 1740 may be split into different rows where each row becomes a vector 1708. There is a limited number of different parameters that may make up parameter matrix 1740, with a limited number of corresponding values. Set of possible parameter values 1704 comprises each of these values. Parameter matrix 1740 may be n bits (e.g., the parameter may be an n-bit value) and set of possible parameter values may have a cardinality of 2ⁿ bits. Parameter matrix 1740 may be a neural network matrix.

Each vector 1708 may be further split into individual values. These vector values may each be multiplied by set of possible parameter values 1704 by multipliers 1714. In specific embodiments, multipliers 1714 may include serializers 1715 and multipliers 1714 may be bit serial multipliers. Multipliers 1714 may be associated with every value in vector 1708 in a one-to-one correspondence. Multipliers 1714 may be associated with every potential value of the parameter. Multipliers 1714 may output the product of a vector value and a possible parameter value as product output 1712. Product output 1712 may be analog reference voltages.

Connectivity mesh 1710 may connect product output 1712 with corresponding readable cells 1706. Connectivity mesh 1710 may be configurable when system 1700 is operational or when system 1700 is being fabricated. In specific embodiments, connectivity mesh 1710 may be formed in metal layers of integrated circuit 1735.

In specific implementations, the number of readable cells 1706 will be equivalent to the number of parameters in parameter matrix 1740. For example, the number of readable cells 1706 in an integrated circuit implementation can be on the giga-scale where the readable cells 1706 are uniquely associated with billions of parameters. The set of readable cells 1706 may be uniquely associated with a parameter of vector 1708 or a parameter of parameter matrix 1740. The set of readable cells 1706 and the parameters are associated in a one-to-one correspondence and the set of readable cells 1706 are ordered to match the order of the parameters in parameter matrix 1740. Notably, readable cells 1706 are not associated directly with the values for the parameters but are instead associated with the parameters themselves. In other words, readable cells 1706 are each associated with an entry of the parameter matrix 1740 and are ordered to match the order of those entries. In specific embodiments, each readable cell 1706 may consist essentially of an access transistor.

In specific embodiments of the invention, the set of readable cells 1706 can be addressable by read circuit 1720. In specific embodiments, read circuit 1720 may include deserializers 1721. Read circuit 1720 can be used to retrieve mapped output 1717 (values associated with the multiplication of vector 1708) from readable cells 1706. Read circuit 1720 can address a given subset of readable cells to read the multiple mapped outputs 1717 in parallel. Read circuit 1720 can be configured to read the same set of readable cells 1706 later when a different input vector value (from vector 1708) has been provided to the multipliers 1714 or a different set of readable cells later when the same input vector value (from vector 1708) has been provided to the multipliers 1714 to obtain the results of a variety of scalar-vector multiplications. Read circuit 1720 can be configured to read a first subset of the set of readable cells 1706 associated with a first word line independently, and a second subset of the set of readable cells 1706 associated with a second word line independently. The way read circuit 1720 is configured to do so can be like the approaches used in standard ROM, RAM, or flash memories in which different sets of memory cells are commonly connected to a word line and can be read in parallel or individually with the assistance of a bit line selection.

In specific embodiments of the invention, system 1700 can include accumulator 1723. Accumulator 1723 can be coupled to read circuit 1720. As read circuit 1720 reads mapped output 1717, accumulator 1723 can accumulate the values of mapped output 1717 with a stored value. In this way, matrix multiplication can be facilitated by conducting the multiply-accumulate operations as readable cells 1706 are read in sequence and the resulting mapped output 1717 (e.g., product values) are accumulated in accumulator 1723. In specific embodiments of the invention, system 1700 can include multiple read circuits and accumulators so that a specific input can be multiplied by separate vectors simultaneously.

In specific embodiments of the invention, system 1700 can include adder 1722. Adder 1722 may be a parallel adder and may be a bit serial adder. Adder 1722 can be a large adder that can take in mapped outputs 1717 (e.g., output vectors) from several subsets of readable cells 1706 and add the values together in parallel. For example, adder 1722 could take in five large vectors of length X that are read (e.g., via read circuit 1720) from five subsets of readable cells 1706 and add the corresponding parameters of each of the five mapped outputs 1717 in a single clock cycle to produce an output vector of length X (e.g., answer vector 1730) equal to the sum of all those mapped outputs 1717. In this manner, system 1700 could be configured to do the multiply and accumulate steps for a matrix multiplication in a single clock cycle. In specific embodiments, the set of possible parameter values 1704 (e.g., parameters of a given matrix) could be associated with more than one readable cell with the different readable cells 1706 each associated with more than one set of multipliers 1714 so that multiple input values (e.g., corresponding to vector 1708) could be multiplied by set of possible parameter values 1704 and accumulated in parallel in a single clock cycle. In specific embodiments, readable cells 1706 associated with more than one vector 1708 could be read and added in parallel so that a single input value could be multiplied by different vectors and accumulated in parallel in a single clock cycle.

In specific embodiments of the invention, system 1700 can include control circuit 1745 that is configured to provide a first address to the set of readable cells 1706 when the input possible parameter value has a first value to generate a first mapped output (e.g., a product) for read circuit 1720 and provide a second address to the set of readable cells 1706 when the input possible parameter value has the first value to generate a second mapped output (e.g., a product) for read circuit 1720. Read circuit 1720 can be coupled to accumulator 1723 that accumulates the first mapped output and the second mapped output. Using this approach, control circuit 1745 can read out a value for multiplying the input value by multiple vectors and accumulate them. Control circuit 1745 can be configured to do so in the same manner that is used by a microcontroller, core controller, or other control circuitry when accessing specific addresses in a memory array with the delivery of an input operand to a computational element in the standard operation of a computation pipeline.

In specific embodiments of the invention, system 1700 can include control circuit 1745 that is configured to provide a first address to the set of readable cells 1706 when the input possible value 1704 has a first value to generate a first product output for read circuit 1720 and provide the first address to the set of readable cells 1706 when the input possible value 1704 has a second value to generate a second product output for read circuit 1720. Read circuit 1720 can be coupled to accumulator 1723 that accumulates the first mapped output and the second mapped output. Using this approach, control circuit 1745 can read out a value for multiplying two different input values with a single vector and accumulate them. Control circuit 1745 can be configured to do so in the same manner that is used by a microcontroller, core controller, or other control circuitry when accessing specific addresses in a memory array with the delivery of input operands to a computational element in the standard operation of a computation pipeline.

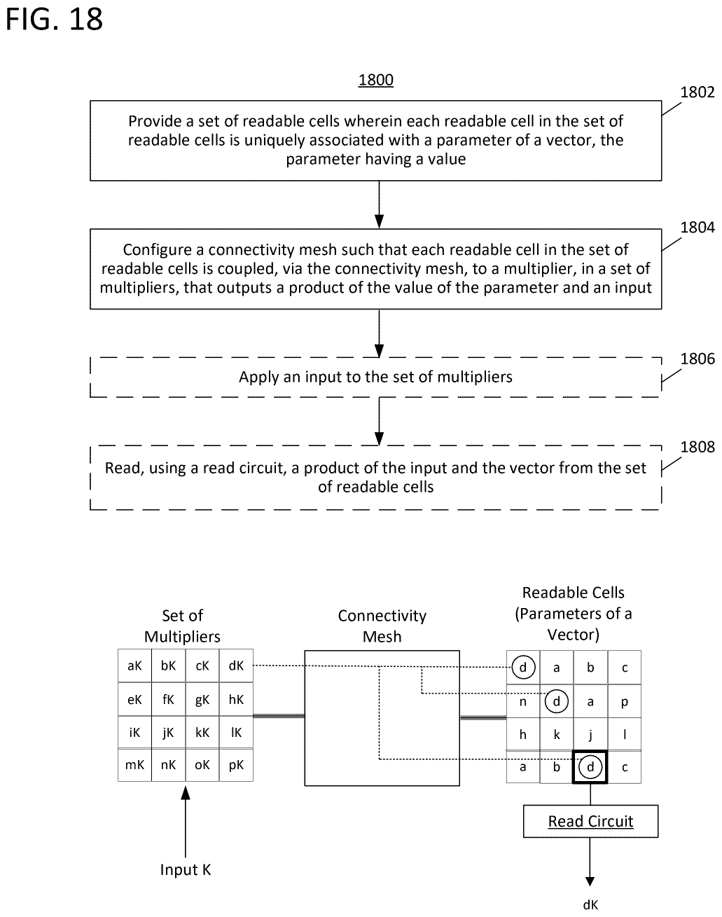

FIG. 18 illustrates an example of method 1800 for accelerated matrix multiplication in accordance with specific embodiments of the inventions disclosed herein. In specific embodiments, steps or portions of steps of method 1800 may be rearranged, omitted, or duplicated, or may otherwise deviate from the format shown.

At step 1802, a set of readable cells is provided. Each readable cell in the set of readable cells may be uniquely associated with a parameter of a vector. The parameter may have a value.

At step 1804, a connectivity mesh may be configured. The connectivity mesh may be configured such that each readable cell in the set of readable cells is coupled, via the connectivity mesh to a multiplier, in a set of multipliers, that outputs a product of the value of the parameter and an input. In specific embodiments, the set of multipliers may be associated with every potential value of the parameter.

In specific embodiments, at step 1806, an input may be applied to the set of multipliers.

In specific embodiments, at step 1808, a product of the input and the vector may be read from the set of readable cells. The product of the input and the vector may be read using a read circuit. Method 1800 may improve the efficiency of matrix multiplication, saving time and power while having low fabrication costs.

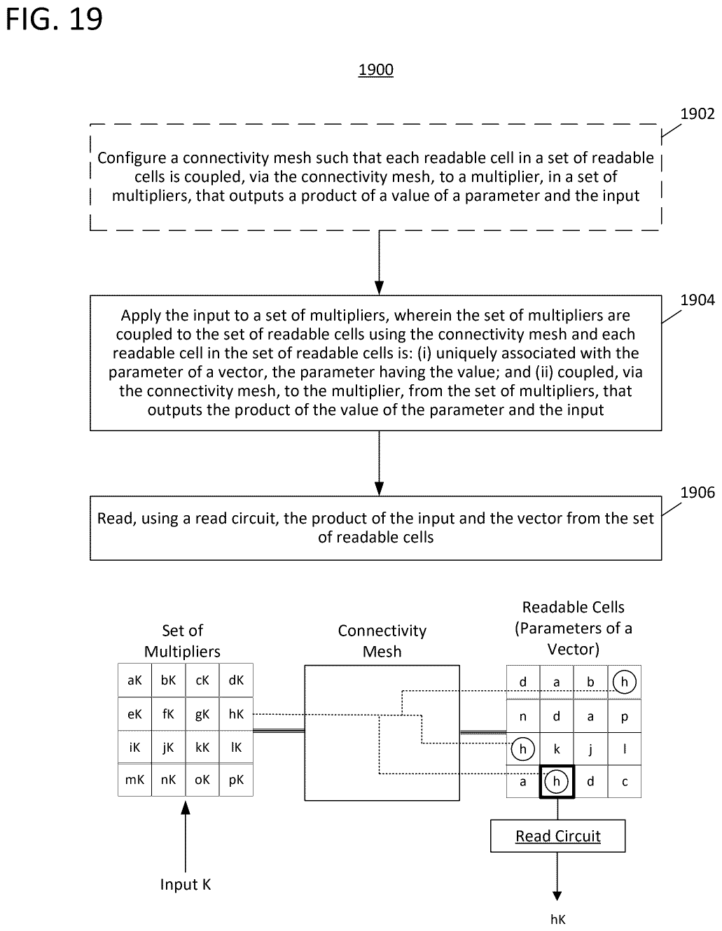

FIG. 19 illustrates an example of method 1900 for accelerated matrix multiplication in accordance with specific embodiments of the inventions disclosed herein. In specific embodiments, steps or portions of steps of method 1900 may be rearranged, omitted, or duplicated, or may otherwise deviate from the format shown.

In specific embodiments, at step 1902, a connectivity mesh may be configured. The connectivity mesh may be configured prior to applying an input (e.g., at step 1904). The connectivity mesh may be configured such that each readable cell in a set of readable cells is coupled, via the connectivity mesh, to a multiplier that outputs a product of a value of a parameter and the input. The multiplier may be in a set of multipliers.

At step 1904, the input may be applied to the set of multipliers. The set of multipliers may be coupled to the set of readable cells using the connectivity mesh. Each readable cell in the set of readable cells may be uniquely associated with the parameter of a vector. The parameter may be associated with (e.g., have) the value. Each readable cell in the set of readable cells may be coupled, via the connectivity mesh, to the multiplier that outputs a product of the value of the parameter and the input. The multiplier may be from the set of multipliers.

At step 1906, the product of the input and the vector from the set of readable cells may be read. The product of the input and the vector from the set of readable cells may be read using a read circuit. Method 1900 may improve the efficiency of matrix multiplication, saving time and power while having low fabrication costs.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure were generally directed to machine intelligence applications, the same approaches could be utilized to other computationally intensive applications including cryptographic computations, ray tracing computations, and others. As another example, although examples in the disclosure were generally directed to computations in which multiplication operations must be conducted on a data structure with a number of parameters that is much larger than the potential values of those parameters, the same approaches can be used for different operations in place of the multiplication such as division, subtraction, addition, roots, logarithms, exponents, factorials, and any other mathematical or logical operation. These and other modifications and variations to the present invention may be practiced by those skilled in the art, without departing from the scope of the present invention, which is more particularly set forth in the appended claims.

What is claimed is:

1. A system comprising:
a set of multipliers input-coupled to an input;
a connectivity mesh;
a set of readable cells wherein each readable cell in the set of readable cells is: (i) uniquely associated with a parameter of a vector, the parameter having a value; and (ii) coupled, via the connectivity mesh, to a multiplier, from the set of multipliers, that outputs a product of the value of the parameter and the input; and
a read circuit that reads the product of the value of the parameter and the input from the set of readable cells.

2. The system of claim 1, wherein:
the set of multipliers are associated with every value in the vector in a one-to-one correspondence.

3. The system of claim 1, wherein:
the set of multipliers is associated with every potential value of the parameter.

4. The system of claim 3, wherein:
the parameter is an n-bit value; and
the set of multipliers has a cardinality of two to the n power.

5. The system of claim 1, wherein:
the set of multipliers includes a set of serializers; and
the read circuit includes a set of deserializers.

6. The system of claim 1, wherein:
the set of multipliers is a set of bit serial multipliers; and
the system further comprises a set of bit serial adders coupled to the read circuit.

7. The system of claim 1, wherein:
the set of multipliers outputs a set of analog reference voltages to the set of readable cells.

8. The system of claim 1, wherein:
the connectivity mesh is configurable when the system is operational.

9. The system of claim 1, wherein:
the connectivity mesh is configurable when the system is being fabricated.

10. The system of claim 1, wherein:
the system is implemented on an integrated circuit; and
the connectivity mesh is formed in metal layers of the integrated circuit.

11. The system of claim 1, wherein:
the set of readable cells is addressable by the read circuit; and
the read circuit is configured to read: (i) a first subset of the set of readable cells associated with a first word line independently; and (ii) a second subset of the set of readable cells associated with a second word line independently.

12. The system of claim 1, wherein:
each readable cell in the set of readable cells consists essentially of an access transistor.

13. The system of claim 1, further comprising:
a parallel adder coupled to the read circuit that adds the product and a second product from the set of readable cells.

14. The system of claim 1, further comprising:
an accumulator coupled to the read circuit that accumulates the product of the input and the vector from the set of readable cells with a stored value.

15. The system of claim 1, further comprising:
a control circuit configured to: (i) provide a first address to the set of readable cells when the input has a first value to generate a first product for the read circuit; and (ii) provide a second address to the set of readable cells when the input has a second value to generate a second product for the read circuit; and
an accumulator coupled to the read circuit that accumulates the first product and the second product.

16. A method comprising:
providing a set of readable cells wherein each readable cell in the set of readable cells is uniquely associated with a parameter of a vector, the parameter having a value; and
configuring a connectivity mesh such that each readable cell in the set of readable cells is coupled, via the connectivity mesh, to a multiplier, in a set of multipliers, that outputs a product of the value of the parameter and an input.

17. The method of claim 16, further comprising:
applying the input to the set of multipliers; and
reading, using a read circuit, the product of the value of the parameter and the input from the set of readable cells.

18. The method of claim 16, wherein:
the set of multipliers is associated with every potential value of the parameter.

19. A method comprising:
applying an input to a set of multipliers, wherein the set of multipliers are coupled to a set of readable cells using a connectivity mesh and each readable cell in the set of readable cells is: (i) uniquely associated with a parameter of a vector, the parameter having a value; and (ii) coupled, via the connectivity mesh, to a multiplier, from the set of multipliers, that outputs a product of the value of the parameter and the input; and
reading, using a read circuit, the product of the value of the parameter and the input from the set of readable cells.

20. The method of claim 19, further comprising:
configuring, prior to applying the input, the connectivity mesh such that each readable cell in the set of readable cells is coupled, via the connectivity mesh, to the multiplier, in the set of multipliers, that outputs the product of the value of the parameter and the input.
